(19) United States
(12) Patent Application Publication
(10) Pub. No.: US 2025/0121357 A1
(43) Pub. Date: Apr. 17, 2025

(54) DUAL FUNCTIONAL AMINOSILICA FOR CO2 CAPTURE

(71) Applicant: EXXONMOBIL TECHNOLOGY AND ENGINEERING COMPANY, Spring, TX (US)

(72) Inventors: David C. CALABRO, Bridgewater, NJ (US); Shabab A. ABEDI, Cedar Knolls, NJ (US); Hilda B. VROMAN, Piscataway, NJ (US); Peter I. RAVIKOVITCH, Princeton, NJ (US); Giovanni M. MURARO, Wescosville, PA (US); Scott J. WEIGEL, Allentown, PA (US)

(21) Appl. No.: 18/915,696

(22) Filed: Oct. 15, 2024

Related U.S. Application Data
(60) Provisional application No. 63/590,593, filed on Oct. 16, 2023.

(51) Int. Cl. B01J 20/32; B01D 53/02; B01J 20/26; B01J 20/28

(52) U.S. Cl. CPC B01J 20/3278; B01D 53/02; B01J 20/264; B01J 20/28061; B01J 20/28064; B01J 20/28066; B01J 20/28071; B01J 20/28073; B01J 20/28076; B01J 20/3212; B01D 2253/202; B01D 2253/306; B01D 2253/311

(57) ABSTRACT

Methods are provided for making amine-functionalized organosilica materials that include additional amine functionalities that are grafted to the composition after the initial synthesis. Methods of using such materials are also provided. It has been discovered that additional aminosilyl groups can be grafted onto amine-functionalized organosilica materials under conditions that substantially preserve the original CO₂ sorption capacity of the underlying organosilica material prior to grafting. This allows the additional amines in the grafted aminosilyl groups to increase the net capacity of the grafted material, as opposed to primarily replacing the original CO₂ sorption capacity with the sorption capacity of the grafted amine functionalities.

### CROSS REFERENCE TO RELATED APPLICATION

This non-provisional patent application claims priority to U.S. provisional patent app. No. 63/590,593, filed Oct. 16, 2023, and titled “AMINE-FUNCTIONAL AEROGELS FOR ACID GAS REMOVAL,” the entire contents of which is incorporated herein by reference.

### FIELD OF THE INVENTION

Amine-functionalized aerogel compositions are provided that are capable of sorption and desorption of acid gas components.

### BACKGROUND OF THE INVENTION

Porous inorganic solids have found great utility as catalysts and separation media for industrial application. In particular, mesoporous materials, such as silicas and aluminas, having a periodic arrangement of mesopores are attractive materials for use in adsorption, separation and catalysis processes due to their uniform and tunable pores, high surface areas and large pore volumes. The pore structure of such mesoporous materials is large enough to absorb large molecules and the pore wall structure can be as thin as about 1 nm. Further, such mesoporous materials are known to have large specific surface areas (e.g., 1000 m²/g) and large pore volumes (e.g., 1 cm³/g). For these reasons, such mesoporous materials enable reactive catalysts, adsorbents composed of a functional organic compound, and other molecules to rapidly diffuse into the pores and therefore, can be advantageous over zeolites, which have smaller pore sizes. Consequently, such mesoporous materials can be useful not only for catalysis of high-speed catalytic reactions, but also as large capacity adsorbents.

It was further discovered that the inclusion of some organic groups in the mesoporous framework can provide adjustable reactive surfaces and also contributes to uniformity in pore size, higher mechanical strength, and hydrothermal stability of the material. Thus, mesoporous organosilica materials can exhibit unique properties compared to mesoporous silica such as enhanced hydrothermal stability, chemical stability, and mechanical properties. Organic groups can be incorporated using bridged silsesquioxane precursors of the form Si—R—Si to form mesoporous organosilicas.

Mesoporous organosilicas are conventionally formed by the self-assembly of the silsequioxane precursor in the presence of a structure directing agent, a porogen and/or a framework element. The precursor is hydrolysable and condenses around the structure directing agent. These materials have been referred to as Periodic Mesoporous Organosilicates (PMOs), due to the presence of periodic arrays of parallel aligned mesoscale channels. For example, Landskron, K., et al. [Science, 302:266-269 (2003)] report the self-assembly of 1,3,5-tris[diethoxysila]cylcohexane [(EtO)₂SiCH₂]₃ in the presence of a base and the structure directing agent, cetyltrimethylammonium bromide to form PMOs that are bridged organosilicas with a periodic mesoporous framework, which consist of SiO₃R or SiO₂R₂ building blocks, where R is a bridging organic group. In PMOs, the organic groups can be homogenously distributed in the pore walls. U.S. Pat. Pub. No. 2012/0059181 reports the preparation of a crystalline hybrid organic-inorganic silicate formed from 1,1,3,3,5,5 hexaethoxy-1,3,5 trisilyl cyclohexane in the presence of NaAlO₂ and base. U.S. Patent Application Publication No. 2007/003492 reports preparation of a composition formed from 1,1,3,3,5,5 hexaethoxy-1,3,5 trisilyl cyclohexane in the presence of propylene glycol monomethyl ether.

However, the use of a structure directing agent, such as a surfactant, in the preparation of an organosilica material, such as a PMO, requires a complicated, energy intensive process to eliminate the structure directing agent at the end of the preparation process. This limits the ability to scale-up the process for industrial applications. Therefore, there is a need to provide additional organosilica materials with a desirable pore diameter, pore volume and surface area. Further, there is a need to provide such organosilica materials that can be prepared by a method that can be practiced in the absence of a structure directing agent, a porogen or surfactant.

U.S. Pat. No. 10,207,249 describes organosilica materials and uses thereof.

### SUMMARY OF THE INVENTION

In an aspect, a method for making a grafted organosilica material is provided. The method includes providing an organosilica material comprising a polymer of at least one repeat unit of Formula (1),

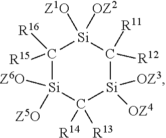

the organosilica material having a nitrogen content of 2.0 wt % to 9.5 wt %, a surface area of 100 m²/g or more, and a pore volume of 0.15 cm³/g or more; forming a suspension of the organosilica material in a solvent. The method further includes exposing at least a portion of the suspension of organosilica material to one or more aminosilane precursors under grafting conditions to form a grafted organosilica material, wherein Z¹, Z², Z³, Z⁴, Z⁵, and Z⁶ each independently represent a hydrogen atom, a C₁-C₄ alkyl group, a bond to a silicon atom of another repeat unit of Formula (1), a bond to an aminosilyl group, a bond to a silicon atom that is bonded to three alkoxy groups, or a bond to a silicon atom of a secondary repeat unit, the secondary repeat unit optionally comprising an acyclic alkoxy silane, and wherein R¹¹, R¹², R¹³, R¹⁴, R¹⁵, and R¹⁶ each independently represent a hydrogen atom or a C₁-C₄ alkyl group. A nitrogen content of the grafted organosilica material can be higher than the nitrogen content of the organosilica material by 0.5 wt % or more. A ratio of a surface area of the grafted organosilica material to the surface area of the organosilica material can be 0.25 or higher. A ratio of a pore volume of the grafted organosilica material to the pore volume of the organosilica material can be 0.4 or higher.

### BRIEF DESCRIPTION OF THE DRAWINGS

FIG. 1 shows a depiction of hexa-ethoxy trisilacyclohexane.

FIG. 2 shows a depiction of N-(aminoethyl)aminopropyl trialkoxysilane.

FIG. 3 shows a depiction of N-(aminoethyl)aminopropyl dialkoxymethylsilane.

FIG. 4 shows a process flow for forming an intermediate gel.

FIG. 5 shows surface area versus nitrogen content for gels dried using supercritical CO₂ and gels dried using conventional vacuum drying.

FIG. 6 shows pore volume versus nitrogen content for gels dried using supercritical CO₂ and gels dried using conventional vacuum drying.

FIG. 7 shows CO₂ isotherms for gels having various nitrogen contents that were dried using conventional vacuum drying.

FIG. 8 shows CO₂ isotherms for gels having various nitrogen contents that were dried using supercritical CO₂.

FIG. 9 shows the ratio of sorbed CO₂ to nitrogen in the material as a function of nitrogen content for gels dried using supercritical CO₂ and gels dried using conventional vacuum drying.

FIG. 10 shows sorption and desorption of CO₂ under cyclic exposure conditions for high nitrogen content gels dried by various methods.

FIG. 11 shows CO₂ isotherms for organosilica materials formed using TDA as the aminosilane precursor.

FIG. 12 shows CO₂ isotherms for organosilica materials formed using an alternative aminosilane precursor.

FIG. 13 shows CO₂ isotherms for organosilica materials formed using another alternative aminosilane precursor.

FIG. 14 shows an example of a monomer unit of the polymer corresponding to an organosilica material.

FIG. 15 shows an example of a precursor organosilane for forming the monomer unit shown in FIG. 14.

FIG. 16 shows a depiction of penta-ethoxy mono-siloxy-trisilacyclohexane.

FIG. 17 shows an example of a reaction scheme for making a dual-functionalized organosilica via grafting.

FIG. 18 shows CO₂ sorption data for an organosilica material before and after grafting.

FIG. 19 shows CO₂ adsorption isotherms at various temperatures for an organosilica material before and after grafting.

FIG. 20 shows CO₂ sorption capacity for organosilica materials during cyclic exposure to an oxidizing environment.

### DETAILED DESCRIPTION OF THE INVENTION

In various aspects, methods are provided for making amine-functionalized organosilica materials that include additional amine functionalities that are grafted to the composition after the initial synthesis. Methods of using such materials are also provided. It has been discovered that additional aminosilyl groups can be grafted onto amine-functionalized organosilica materials under conditions that substantially preserve the original CO₂ sorption capacity of the underlying organosilica material prior to grafting. This allows the additional amines in the grafted aminosilyl groups to increase the net capacity of the grafted material, as opposed to primarily replacing the original CO₂ sorption capacity with the sorption capacity of the grafted amine functionalities. In this discussion, the material that is produced by grafting additional aminosilyl groups to an amine-functionalized organosilica material can be referred to as a dual-functionalized organosilica material, or alternatively a dual-amine-functionalized organosilica material.

Amine-functionalized organosilica materials are high surface area, high pore volume materials that can be used for adsorption of CO₂. Conventionally, it would be expected that attempting to graft additional aminosilyl groups onto such amine-functionalized organosilica materials would have several impacts on the composition. While additional aminosilyl groups could be grafted to the material, it would be expected that substantial decreases in surface area and/or pore volume would be observed. Due in part to these decreases in surface area and pore volume, it would further be expected that grafting of additional aminosilyl groups onto an amine-functionalized organosilica material would result in little or no increase in CO₂ sorption capacity, and in fact would instead result in a net decrease in sorption capacity. This conventional result would be expected based on the conventional understanding that any addition of amine functionalities by grafting of aminosilyl groups would be more than offset by the loss of sorption capacity for other amine functionalities present in the underlying substrate. For example, it would be expected that amine functionalities present within the pore network of the underlying organosilica material would become inaccessible due to pore filling during the grafting process.

It has now been discovered that additional amine functionalities (in the form of aminosilyl groups) can be grafted onto amine-functionalized organosilica materials while preserving a substantial portion of the CO₂ sorption capacity of the underlying material prior to grafting. This results in a dual-functionalized organosilica material. It has been discovered that the grafting can be performed under sufficiently mild conditions that a substantial portion of the original CO₂ sorption capacity is preserved, so that the addition of the grafted material results in an increase in overall capacity. Additionally, in spite of the mild conditions, the grafting results in a structure that substantially retains CO₂ sorption capacity after multiple sorption/desorption cycles, indicating that the grafted aminosilyl groups are bound strongly enough to the organosilica to remain part of the structure during repeated heating and cooling cycles and/or cyclic pressure changes.

### Definitions

For purposes of this invention and the claims hereto, the numbering scheme for the Periodic Table Groups is according to the IUPAC Periodic Table of Elements.

The terms “substituent”, “radical”, “group”, and “moiety” may be used interchangeably.

As used herein, and unless otherwise specified, the term “Cₙ” means hydrocarbon(s) having n carbon atom(s) per molecule, wherein n is a positive integer.

As used herein, and unless otherwise specified, the term “hydrocarbon” means a class of compounds containing hydrogen bound to carbon, and encompasses (i) saturated hydrocarbon compounds, (ii) unsaturated hydrocarbon compounds, and (iii) mixtures of hydrocarbon compounds (saturated and/or unsaturated), including mixtures of hydrocarbon compounds having different values of n.

A hydrocarbonaceous compounds refers to an organic compound that differs from a hydrocarbon in that one or more atoms different from carbon or hydrogen are present in the compound.

As used herein, and unless otherwise specified, an acyclic compound, group, or substituent refers to a compound, group, or substituent that does not include a ring structure.

As used herein, and unless otherwise specified, the term “alkyl” refers to a saturated hydrocarbon radical having from 1 to 12 carbon atoms (i.e. C₁-C₁₂ alkyl), particularly from 1 to 8 carbon atoms (i.e. C₁-C₈ alkyl), particularly from 1 to 6 carbon atoms (i.e. C₁-C₆ alkyl), and particularly from 1 to 4 carbon atoms (i.e. C₁-C₄ alkyl). Examples of alkyl groups include, but are not limited to, methyl, ethyl, propyl, butyl, pentyl, hexyl, heptyl, octyl, decyl, and so forth. The alkyl group may be linear, branched or cyclic. “Alkyl” is intended to embrace all structural isomeric forms of an alkyl group. For example, as used herein, propyl encompasses both n-propyl and isopropyl; butyl encompasses n-butyl, sec-butyl, isobutyl and tert-butyl and so forth. As used herein, “C₁ alkyl” refers to methyl (—CH₃), “C₂ alkyl” refers to ethyl (—CH₂CH₃), “C₃ alkyl” refers to propyl (—CH₂CH₂CH₃) and “C₄ alkyl” refers to butyl (e.g. —CH₂CH₂CH₂CH₃, —(CH₃)CHCH₂CH₃, —CH₂CH(CH₃)₂, etc.). As used herein, and unless otherwise specified, the term “alkylene” refers to a divalent alkyl moiety containing 1 to 12 carbon atoms (i.e. C₁-C₁₂ alkylene) in length and meaning the alkylene moiety is attached to the rest of the molecule at both ends of the alkyl unit. For example, alkylenes include, but are not limited to, —CH₂—, —CH₂CH₂—, —CH(CH₃)CH₂—, —CH₂CH₂CH₂—, etc. The alkylene group may be linear or branched.

As used herein, and unless otherwise specified, an aminosilane refers to a hydrocarbonaceous compound that includes at least one silicon atom and at least one nitrogen atom that corresponds to an amine nitrogen, with an alkyl group between the at least one silicon atom and the at least one nitrogen atom. An aminosilyl group refers to a hydrocarbonaceous radical that includes at least one silicon atom and at least one nitrogen atom that corresponds to an amine nitrogen, with an alkyl group between the at least one silicon atom and the at least one nitrogen atom.

As used herein, and unless otherwise specified, the term “alkoxy” refers to —O-alkyl containing from 1 to about 10 carbon atoms. The alkoxy may be straight-chain or branched-chain. Non-limiting examples include methoxy, ethoxy, propoxy, butoxy, isobutoxy, tert-butoxy, pentoxy, and hexoxy. “C₁ alkoxy” refers to methoxy, “C₂ alkoxy” refers to ethoxy, “C₃ alkoxy” refers to propoxy and “C₄ alkoxy” refers to butoxy. Further, as used herein, “OMe” refers to methoxy and “OEt” refers to ethoxy.

As used herein, the term “hydroxyl” refers to an —OH group.

As used herein, the term “mesoporous” refers to solid materials having pores that have a diameter within the range of from about 2 nm to about 50 nm.

As used herein, the term “organosilica” refers to an organosilane compound that comprises one or more organic groups bound to two or more Si atoms.

As used herein, the term “silanol” refers to a Si—OH group.

As used herein, the term “silanol content” refers to the percent of the Si—OH groups in a compound and can be calculated by standard methods, such as NMR.

As used herein, the terms “structure directing agent,” “SDA,” and/or “porogen” refer to one or more compounds added to the synthesis media to aid in and/or guide the polymerization and/or polycondensing and/or organization of the building blocks that form the organosilica material framework. Further, a “porogen” is understood to be a compound capable of forming voids or pores in the resultant organosilica material framework. As used herein, the term “structure directing agent” encompasses and is synonymous and interchangeable with the terms “templating agent” and “template.”

As used herein, and unless otherwise specified, the term “adsorption” includes physisorption, chemisorption, and condensation onto a solid material and combinations thereof.

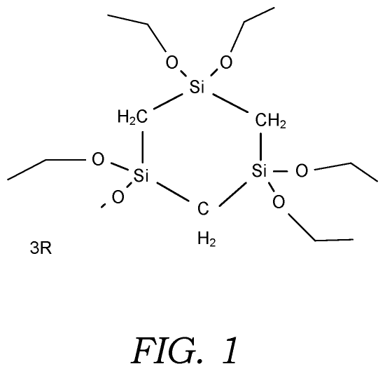

In this discussion, the ring structure corresponds to the atoms that form the cyclic structure. The members of a ring structure can be identified as the atoms that form a continuous loop without having to trace a path through an atom more than once. For example, in cyclohexane, all of the carbon atoms are part of the ring structure, but none of the hydrogen atoms are part of the ring structure. As another example, in the compound shown in FIG. 1, the ring structure includes the three silicon atoms and three carbon atoms that correspond to the six membered ring. None of the ethoxy groups shown in FIG. 1 are part of the ring structure.

### Grafting to Form Dual-Functionalized Organosilica Materials

After forming an amine-functionalized organosilica material, additional aminosilyl groups can be grafted to the organosilica material. The aminosilyl groups can be the same as the types of aminosilyl groups that were present during synthesis of the organosilica material, or the aminosilyl groups can be different, or a combination thereof.

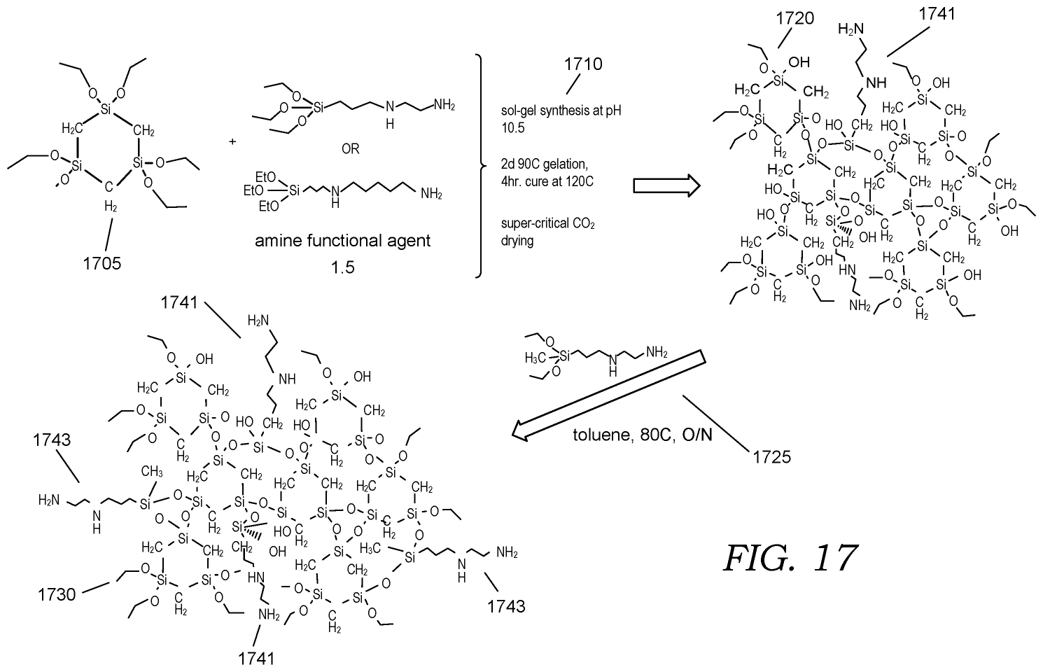

FIG. 17 shows an example of a synthesis method for forming a dual-functionalized organosilica material. First, an amine-functionalized organosilica material is formed. In the example shown in FIG. 17, the amine-functionalized organosilica material is synthesized based on solgel condensation of a cyclic organosilane precursor 1705 in the presence of an aminosilane precursor 1707. Two examples of aminosilane precursors 1707 are shown in FIG. 17. In the example shown in FIG. 17, the reaction 1710 is performed by forming an aqueous solution of the reagents at a pH of roughly 10.5. The solution is maintained at 90° C. for roughly 2 days to allow for gelation, followed by curing for four hours at 120° C. The resulting gel is then dried. In the example shown in FIG. 17, a supercritical fluid drying process is used to dry the resulting amine-functionalized organosilica material 1720, but any other convenient type of drying could be used instead, depending on the aspect. The example of the amine-functionalized organosilica material 1720 shown in FIG. 17 includes two locations 1741 where an aminosilyl group is present within the structure. After drying, grafting step 1725 is performed by suspending at least a portion of the amine-functionalized organosilica material 1720 in a solvent, such as toluene, in the presence of one or more types of additional aminosilane precursors 1727 that will be grafted onto the material 1720. The additional aminosilanes 1727 are reacted with the material 1720 under grafting conditions to form dual-functionalized organosilica material 1730. In the example shown in FIG. 17, the dual-functionalized organosilica material 1730 includes aminosilyl groups that were added in two different manners. Aminosilyl groups 1741 correspond to aminosilyl groups that were added during the initial formation of the organosilica material. Aminosilyl groups 1743 correspond to additional aminosilyl groups that were grafted onto the organosilica material after the initial formation and drying of the underlying material. Thus, material 1730 corresponds to a dual-functionalized organosilica material, with both functionalizations corresponding to amine-functionalization.

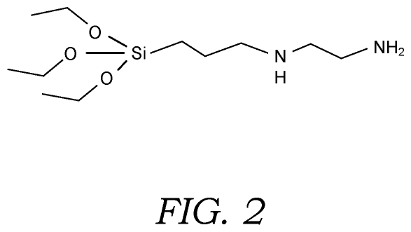

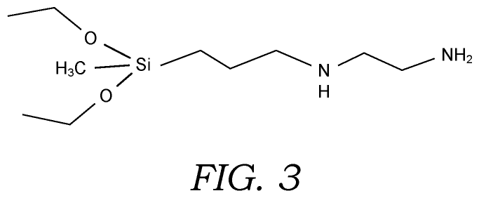

Examples of aminosilane precursors that can be grafted to amine-functionalized organosilicas are N-(aminoalkyl)aminoalkyl polyalkoxysilanes. In some aspects, the N-(aminoalkyl)aminoalkyl polyalkoxysilane can correspond to a trialkoxysilane. An example of an N-(aminoalkyl)aminoalkyl trialkoxysilane is N-(aminoethyl)aminopropyl trialkoxysilane, shown in FIG. 2, which can be referred to as “TDA”. In some aspects, the N-(aminoalkyl)aminoalkyl polyalkoxysilane can correspond to a dialkoxysilane, with at least one alkyl group or hydrogen substituent bonded to the silica atom. An example of a such a compound is N-(aminoethyl)aminopropyl dialkoxymethylsilane, shown in FIG. 3. It is noted that the aminosilane precursor can be an acyclic aminosilane. Still other examples of aminosilane precursors can be aminosilane precursors that contain only a single amine, such as aminopropyltriethoxysilane and aminobutyltriethoxysilane.

In various aspects, each of the aminoalkyl groups in the aminosilane precursor can correspond to a C₁-C₆ aminoalkyl. Optionally, each of the aminoalkyl groups can have the same chain length. Optionally, the N-(aminoalkyl)aminoalkyl alkoxysilane can correspond to an N-(diaminoalkyl)aminoalkyl alkoxysilane. In some aspects, the alkoxy groups can contain 1 to 6 carbons, or 2 to 6 carbons, or 1 to 4 carbons, or 2 to 4 carbons. In some aspects, each of the alkoxy groups attached to the silicon atom can have the same number of carbon atoms (e.g., all alkoxy groups are methoxy, or all alkoxy groups are ethoxy). It is noted that the alkyl groups can optionally be branched, unbranched, or a mixture of branched and unbranched.

The grafting is performed under conditions that allow for grafting of the additional aminosilyl groups while reducing or minimizing loss of the underlying CO₂ sorption capacity of the amine-functionalized organosilica prior to grafting. In various aspects, the grafting is performed by exposing an amine-functionalized organosilica to an aminosilane reagent (or precursor) in a solvent at a temperature of 25° C. to 100° C., or 70° C. to 95° C. In the solution, the weight of aminosilane reagent to amine-functionalized organosilica can range from 1.0 (in other words, 1.0 to 1) to 100, or 5.0 to 100, or 10 to 100, or 3.0 to 40, or 5.0 to 40, or 10 to 40. It is noted that water can also be present in the suspension. For example, in aspects where water is not used as the solvent, a molar amount of water that is roughly similar to the molar amount of aminosilane reagent can be included in the suspension. Any convenient type of solvent that can effectively solvate the aminosilane reagent while also providing a suspension of the amine-functionalized organosilica material can be used. Examples of suitable solvents are water and aromatic solvents, such as toluene.

One of the results of the grafting process is an increase in nitrogen content for the organosilica material. After grafting, the nitrogen content of the grafted material can be higher than the nitrogen content of the amine-functionalized organosilica material prior to grafting by 0.5 wt % or more, or 1.0 wt % or more, or 1.2 wt % or more, or 1.5 wt % or more, such as up to 3.0 wt % or possibly still higher. For example, the nitrogen content of the grafted material can be higher than the nitrogen content of the amine-functionalized organosilica material prior to grafting by 0.5 wt % to 3.0 wt %, or 1.0 wt % to 3.0 wt %, or 1.2 wt % to 3.0 wt %, or 1.5 wt % to 3.0 wt %, or 0.5 wt % to 2.0 wt %, or 1.0 wt % to 2.0 wt %.

### Organosilica Materials and Synthesis of Gel Intermediate—Example of Condensation Method

In various aspects, amine-functionalized organosilicas can be formed based on condensation of an alkoxy-substituted cyclic organosilane in the presence of an aminosilane precursor. This type of process is a single step synthesis process that forms an amine-functionalized polymer. The precursors for the one-step synthesis process include an alkoxy-substituted cyclic organosilane and an aminosilane precursor. It is noted that the alkoxy-substituted cyclic organosilane does not quite correspond to a “monomer” for forming the polymer, as the polymer is not simply the condensation product of the alkoxy-substituted cyclic organosilane. Instead, at least a portion of the alkoxy-substituted cyclic organosilanes also react with the aminosilane precursor during the synthesis, so that the resulting organosilica material is also amine-functionalized. Optionally, a gelator or gelling agent can also be included. For example, an acyclic alkoxy silane compound can be used during the condensation to provide a secondary repeat unit that facilitates formation of the gel. Thus, this synthesis corresponds to a sol-gel condensation of a cyclic organosilane precursor in the presence of an aminosilane precursor. The product of this condensation would be expected to possess anchored amine functional groups distributed throughout on both external surface and within the bulk of the network structure. The condensation method involves forming an intermediate gel based on a precursor corresponding to a cyclic organosilane, such as a trisilacyclohexane, combined with an aminosilane precursor, such as for example, N-(aminoethyl)aminopropyl trialkoxysilane (TDA).

The resulting intermediate gel is then dried. Any convenient type of drying method may be used, such as drying by heating and/or vacuum drying. In some aspects, the drying can correspond to at least one of a supercritical drying process and a freeze drying process. By using a supercritical drying process and/or a freeze drying process, an amine-functionalized organosilica material can be formed that has improved properties for sorption of CO₂. In particular, the amount of nitrogen that can be incorporated into the amine-functionalized organosilica materials while still increasing the CO₂ sorption capacity can be substantially increased.

This type of synthesis, based on condensation of an alkoxy-substituted cyclic organosilane in the presence of an aminosilane precursor, provides at least two unexpected benefits for the resulting amine-functionalized organosilica. First, the amine-functionalized organosilica is formed by a single-step method without the use of a templating agent. This simplifies synthesis and reduces costs associated with the synthesis. Additionally, by using supercritical CO₂ and/or freeze-drying as the drying step(s) to form the resulting gel, improved CO₂ sorption capacity can be achieved relative to the amine loading of the organosilica. This improved CO₂ sorption capacity can be achieved for organosilica materials with elevated nitrogen contents, such as organosilica materials with nitrogen content of 4.0 wt % nitrogen or more.

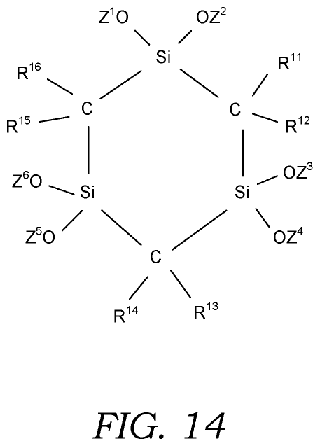

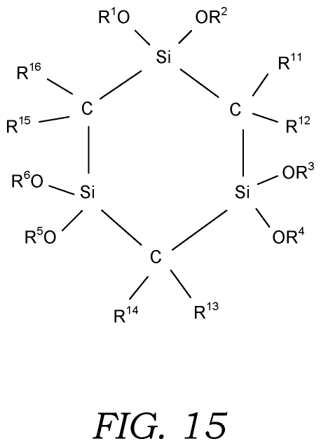

The organosilica material can correspond to a polymer that includes one or more repeat units according to the structure shown in FIG. 14 (Formula 1). FIG. 15 shows an example of a corresponding cyclic organosilane precursor (Formula 2) to produce a polymer that includes repeat units of the type shown in FIG. 14. In FIG. 14, Z¹, Z², Z³, Z⁴, Z⁵, and Z⁶ each independently represent a hydrogen atom, a C₁-C₄ alkyl group, a bond to a silicon atom of another repeat unit of Formula 1, a bond to a silicon atom of an amino-silyl, a bond to a silicon atom that is bonded to three alkoxy groups, or a bond to a silicon atom of a secondary repeat unit, such as a repeat unit comprising an acyclic alkoxy-silyl. In other words, each “Z” location shown in FIG. 14 can correspond to a silanol group, an alkoxy group, a bond to another repeat unit, a bond to an aminosilyl (derived from the aminosilane precursor) that provides the amine functionalization for the polymer, a bond to a siloxy group, or a bond to a secondary repeat unit. It is noted that preferably, only one of Z¹, Z², Z³, Z⁴, Z⁵, and Z⁶ will correspond to a silicon atom that is bonded to three alkoxy groups, as such structures do not contribute to forming a network. In FIG. 14, R¹¹, R¹², R¹³, R¹⁴, R¹⁵, and R¹⁶ each independently represent a hydrogen atom or a C₁-C₄ alkyl group. In aspects where each of R¹¹, R¹², R¹³, R¹⁴, R¹⁵, and R¹⁶ corresponds to a hydrogen atom, the structure in FIG. 14 corresponds to the type of repeat unit present when a hexa-alkoxy trisliacyclohexane is used to make the mixture for forming the gel for the organosilica material.

FIG. 15 shows an example of a cyclic organosilane compound that can be used for forming a gel. In aspects where each of R¹¹, R¹², R¹³, R¹⁴, R¹⁵, and R¹⁶ corresponds to a hydrogen atom, and where each of R¹, R², R³, R⁴, R⁵, and R⁶ correspond to a C₂ alkyl group, FIG. 15 corresponds to 1,1,3,3,5,5-hexa-ethoxy-trisilacyclohexane, which can be referred to as “3R”.

It is noted that the aminosilane precursors are incorporated into the polymer as terminal groups. Therefore, the aminosilane precursors and/or functional groups derived therefrom are not referred to herein as monomers. However, in some aspects, alkoxy-substituted acyclic silanes, such as alkoxy-substituted acyclic aminosilanes, may also be present in the condensation mixture and may contribute secondary repeat units that also form part of the polymer network. Such alkoxy-substituted acyclic silanes (including alkoxy-substituted acyclic aminosilanes) that serve as precursors for secondary repeat unit in the polymer are defined herein as gelator compounds.

In some aspects where supercritical CO₂ drying is used, the nitrogen content of the resulting organosilica materials can be 4.0 wt % to 10 wt %, relative to the weight of the organosilica material, or 4.0 wt % to 9.5 wt %, or 4.0 wt % to 8.3 wt %, or 4.5 wt % to 10 wt %, or 4.5 wt % to 9.5 wt %, or 4.5 wt % to 8.3 wt %, or 5.5 wt % to 10 wt %, or 5.5 wt % to 9.5 wt %, or 5.5 wt % to 8.3 wt %, or 6.5 wt % to 10 wt %, or 6.5 wt % to 9.5 wt %, or 6.5 wt % to 8.3 wt %.

It is noted that the use of supercritical CO₂ drying for the production of high surface area, high porosity and low density silica aerogels is known conventionally. Conventionally, using supercritical CO₂ for drying of conventional aerogels is reported to provide high gas diffusion rates in these materials relative to conventional silica substrates. Supercritical CO₂ drying has also been found to reduce mass transfer resistance in amine-functionalized organosilica formed by conventional two-step synthesis methods.

In other aspects, including in some aspects where conventional drying techniques are used, the nitrogen content of the resulting organosilica materials can be 2.0 wt % to 10 wt %, relative to the weight of the organosilica material, or 2.0 wt % to 9.5 wt %, or 2.0 wt % to 8.3 wt %, or 2.0 wt % to 6.5 wt %, or 4.0 wt % to 10 wt %, or 4.0 wt % to 9.5 wt %, or 4.0 wt % to 8.3 wt %, or 4.0 wt % to 6.5 wt %, or 5.5 wt % to 10 wt %, or 5.5 wt % to 9.5 wt %, or 5.5 wt % to 8.3 wt %, or 6.5 wt % to 10 wt %, or 6.5 wt % to 9.5 wt %, or 6.5 wt % to 8.3 wt %.

An alkoxy-substituted cyclic organosilane is the primary component for forming the organosilica material. An example of an alkoxy-substituted cyclic organosilane is an alkoxy-substituted silacyclohexane, such as hexa-ethoxy trisilacyclohexane. In this discussion, hexa-ethoxy trisilacyclohexane may be referred to as “3R”. FIG. 1 shows a structural representation of hexa-ethoxy trisilacyclohexane.

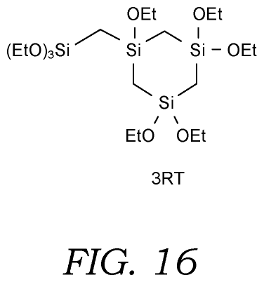

It is noted that in some aspects, instead of using only an alkoxy-substituted cyclic organosilane, a mixture of an alkoxy-substituted cyclic organosilane, such hexa-ethoxy trisilacyclohexane, and an alkoxy-substituted siloxy-substituted cyclic organosilane can be used. An example of an alkoxy-substituted siloxy-substituted cyclic organosilane is an alkoxy-substituted, mono-siloxy-substituted cyclic organosilane, such as penta-ethoxy mono-(triethoxy)siloxy-trisilacyclohexane (i.e., for one silicon position in the ring, the ethoxy group is replaced with a siloxy group). An example of penta-ethoxy mono-(triethoxy)siloxy-trisilacyclohexane is shown in FIG. 16.

In various aspects, the alkoxy-substituted cyclic organosilane can include 3 or more silicon atoms in the ring structure. Optionally, the ring structure can correspond to a 6-membered ring. Optionally, the ring structure can include between 5 to 10 atoms that are part of the cyclic ring structure. Optionally, the ring structure can correspond to a single ring. For the carbons in the ring structure, one option is for the ring carbons to have two hydrogen substituents. In other aspects, one or more of the carbons in the ring structure can have a C₁-C₄ substituent. Larger alkyl groups could be possible, so long as steric hindrance from the alkyl groups does not prevent gel formation. For the alkoxy groups attached to the silicon atoms, the alkoxy groups can contain 1 to 6 carbons, or 2 to 6 carbons, or 1 to 4 carbons, or 2 to 4 carbons. In some aspects, the alkoxy groups attached to the silicon atoms in a single ring can each have the same number of carbon atoms (e.g., all alkoxy groups are methoxy, or all alkoxy groups are ethoxy).

The aminosilane precursor provides the amine-functionalization for the organosilica. Examples of aminosilane precursors that can be used in synthesis of amine-functionalized organosilicas are N-(aminoalkyl)aminoalkyl polyalkoxysilanes. In some aspects, the N-(aminoalkyl)aminoalkyl polyalkoxysilane can correspond to a trialkoxysilane. An example of an N-(aminoalkyl)aminoalkyl trialkoxysilane is N-(aminoethyl)aminopropyl trialkoxysilane, shown in FIG. 2, which can be referred to as “TDA”. In some aspects, the N-(aminoalkyl)aminoalkyl polyalkoxysilane can correspond to a dialkoxysilane, with at least one alkyl group or hydrogen substituent bonded to the silica atom. An example of a such a compound is N-(aminoethyl)aminopropyl dialkoxymethylsilane, shown in FIG. 3. It is noted that the aminosilane precursor can be an acyclic aminosilane. Still other examples of amino silane precursors can be aminosilane precursors that contain only a single amine, such as aminopropyltriethoxysilane and aminobutyltriethoxysilane.

In various aspects, each of the aminoalkyl groups in the aminosilane precursor can correspond to a C₁-C₆ aminoalkyl. Optionally, each of the aminoalkyl groups can have the same chain length. Optionally, the N-(aminoalkyl)aminoalkyl alkoxysilane can correspond to an N-(diaminoalkyl)aminoalkyl alkoxysilane. In some aspects, the alkoxy groups can contain 1 to 6 carbons, or 2 to 6 carbons, or 1 to 4 carbons, or 2 to 4 carbons. In some aspects, each of the alkoxy groups attached to the silicon atom can have the same number of carbon atoms (e.g., all alkoxy groups are methoxy, or all alkoxy groups are ethoxy). It is noted that the alkyl groups can optionally be branched, unbranched, or a mixture of branched and unbranched.

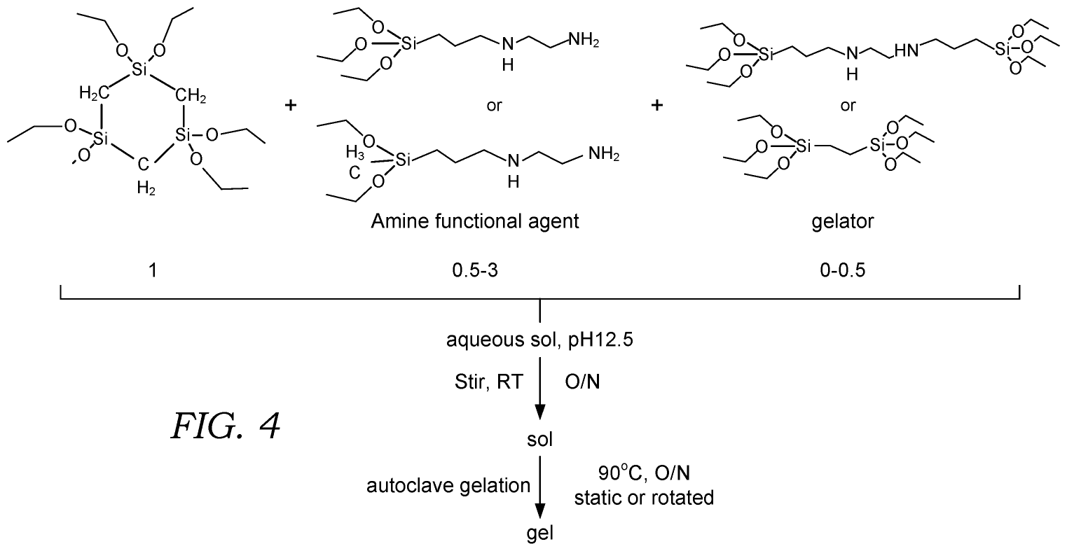

In aspects where a gelator or gelling agent is used, the gelator or gelling agent corresponds to an acyclic polyalkoxysilane compound. The gelator can optionally correspond to an alkyl polyalkoxysilane, or the gelator can optionally correspond to an alkylamine alkoxysilane, or a combination thereof. An example of an alkyl polyalkoxysilane is 1,2-bis(triethoxysilyl)ethane. An example of an alkylamine polyalkoxysilane is N,N′bis[3-(triethoxysilyl)propyl]ethane-1,2-diamine. These example compounds are shown as the “gelator” compounds in FIG. 4. In some aspects, the alkoxy groups attached to the silicon atoms in the gelator can contain 1 to 6 carbons, or 2 to 6 carbons, or 1 to 4 carbons, or 2 to 4 carbons. In some aspects, the alkyl and/or aminoalkyl groups in the gelator can include 1 to 4 carbons.

To form an organosilica compound, the alkoxy-substituted cyclic organosilane and the aminosilane precursor can be combined in a molar ratio of 1:0.5-3.0, or 1:1.0-3.0, or 1:0.5-2.0. In aspects where an optional gelator or gelling agent is used, the alkoxy-substituted cyclic organosilane and the gelator or gelling agent can be combined in a molar ratio of 1:0.2-0.8, or 1:0.2-0.6, or 1:0.4-0.8. Additionally or alternatively, in aspects where additional precursors corresponding to one or more additional types of repeat units are present in the synthesis mixture, the alkoxy-substituted cyclic organosilane and the additional precursors can be combined in a molar ratio of 1:0.2-0.8, or 1:0.2-0.6, or 1:0.4-0.8. In some aspects, to form the organosilica compound, the reagents can be mixed together in an aqueous solution at a pH of 10.5-12.5. The mixture can be mixed for 5.0 hours to 48 hours, such as overnight. More generally, to form the organosilica compound, the reagents can be mixed together in an aqueous solution that has either an acidic or a basic pH. In some aspects, the pH can be roughly 5.0 or less, or 4.0 or less, such as down to 1.0 or possibly still lower. In other aspects, the pH can be roughly 9.5 to 12.5, or 10.5 to 12.5. As a practical matter using an acid wash is effective, but requires additional wash steps relative to using a basic pH to recover the free-base form of the amine-functionalized organosilica material. The mixture can be mixed for 5.0 hours to 48 hours.

After this initial mixing, the mixture is aged to allow for gel formation. Ageing can be performed under a variety of conditions. For example, the mixture can be aged at a temperature of 10° C. to 300° C., or 50° C. to 300° C., or 10° C. to 200° C., or 50° C. to 200° C., or 50° C. to 150° C., or 70° C. to 150° C., or 50° C. to 110° C., or 70° C. to 110° C. The mixture can be maintained at the temperature for 20 hours to 150 hours, or 20 to 60 hours. This produces a gel intermediate. Optionally, the heating of the mixture can be performed in a rotating oven or a stirred reactor to facilitate even heating. After aging, the pre-product is dried to obtain the organosilica material.

The nitrogen content of the resulting organosilica materials (after drying) can be 2.0 wt % to 10 wt %, relative to the weight of the organosilica material, or 2.0 wt % to 9.5 wt %, or 2.0 wt % to 8.3 wt %, or 2.0 wt % to 6.5 wt %, or 4.0 wt % to 10 wt %, or 4.0 wt % to 9.5 wt %, or 4.0 wt % to 8.3 wt %, or 4.0 wt % to 6.5 wt %, or 5.5 wt % to 10 wt %, or 5.5 wt % to 9.5 wt %, or 5.5 wt % to 8.3 wt %, or 6.5 wt % to 10 wt %, or 6.5 wt % to 9.5 wt %, or 6.5 wt % to 8.3 wt %.

When forming a polymeric organosilica material, still other types of precursors/monomers can also be included in the synthesis mixture, in order to provide additional types of repeat units within the resulting organosilica material. As an example, precursors can be included in the synthesis mixture to form one or more repeat units of Formula Z¹⁹Z²⁰Z²¹Si—Z²² (Formula I), wherein each Z¹⁹ represents a nitrogen-containing C₁-C₁₀ alkyl group, a nitrogen-containing heteroaralkyl group, and a nitrogen-containing optionally substituted heterocycloalkyl group; and Z²⁰, Z²¹ and Z²² are each independently selected from the group consisting of a hydrogen atom, a C₁-C₄ alkyl group or a bond to a silicon atom of another repeat unit. As another example, precursors can be included in the synthesis mixture to form one or more repeat units of Formula Z⁷Z⁸Z⁹Si—R¹—SiZ⁷Z⁸Z⁹ (Formula II), wherein each Z⁷, Z⁸ and Z⁹ independently represent a hydroxyl group, a C₁-C₄ alkoxy group or an oxygen bonded to a silicon atom of another repeat unit; and R¹ represents a C₂-C₁₀ alkylene group. In still another example, the organosilica material can be formed based on a synthesis mixture containing the alkoxy-substituted cyclic organosilane precursor, the aminosilane precursor, and precursors for forming repeat units according to both Formula I and Formula II.

In some further aspects, the organosilica material may further comprise still other types of repeat units, in addition to the repeat units based on the alkoxy-substituted cyclic organosilane precursor, the aminosilane precursor, any optional gelator, and any optional precursors for forming repeat units according to Formula I and/or Formula II. For example, the organosilica material can further comprise one or more repeat units corresponding to Formula (III) [Z¹⁰OZ¹¹SiCH₂]₃, wherein each Z¹⁰ can be a hydrogen atom, a C₁-C₄ alkyl group or a bond to a silicon atom of another repeat unit and each Z¹¹ can be a hydroxyl group, a C₁-C₆ alkyl group or an oxygen atom bonded to a silicon atom of another repeat unit. As another example, the organosilica material can further comprise one or more repeat units of Formula (IV) Z¹²—OZ¹³Z¹⁴Z¹⁵Si, wherein each Z¹² can be a hydrogen atom or a C₁-C₄ alkyl group or a bond to a silicon atom of another repeat unit; and Z¹³, Z¹⁴ and Z¹⁵ each independently can be selected from the group consisting of a hydroxyl group, a C₁-C₄ alkyl group, a C₁-C₄ alkoxy group and an oxygen atom bonded to a silicon atom of another repeat unit. As still another example, the organosilica material may further comprise one or more repeat unis of Formula Z¹⁶Z¹⁷Z¹⁸Si—R²—SiZ¹⁶Z¹⁷Z¹⁸ (V), wherein each Z¹⁶ independently represents a hydroxyl group, a C₁-C₄ alkoxy group or an oxygen atom bonded to a silicon atom of another repeat unit; each Z¹⁷ and Z¹⁸ independently represent a hydroxyl group, a C₁-C₄ alkoxy group, a C₁-C₄alkyl group or an oxygen atom bonded to a silicon atom of another repeat unit; and each R² is selected from the group consisting a C₁-C₈ alkylene group, a C₂-C₈ alkenylene group, a C₂-C₈ alkynylene group, an optionally substituted C₆-C₂₀ aralkyl and an optionally substituted C₄-C₂₀ heterocycloalkyl group.

### Organosilica Materials—Drying of Gel Intermediate

After forming a gel intermediate by any of the above methods, the gel intermediate can be dried in any convenient manner. In some aspects, a conventional drying method can be used, such as heating the gel intermediate to a target temperature. In other aspects, the gel intermediate can be dried using supercritical CO₂, freeze drying, or a combination thereof. Preferably, drying can be performed using supercritical CO₂. Both freeze drying and drying with supercritical CO₂ can provide benefits for improving CO₂ sorption (and/or sorption of other compounds). However, this benefit is larger when drying is performed using supercritical CO₂.

Conventionally, the straightforward route for drying an intermediate gel is to heat the intermediate gel to convert the solvent (such as water) in the intermediate gel into a gas, which can then be purged from the gel. Another conventional option for drying an intermediate gel after gel formation is to expose the gel to reduced pressure relative to 100 kPa-a (ambient), such as a pressure of 10 kPa-a or less, in order to convert the liquid solvent in the intermediate gel into a vapor that can then be readily purged from the gel structure using a purge gas.

For a conventional drying process, the drying is performed at a temperature of 20° C. to 300° C., or 20° C. to 150° C., or 50° C. to 300° C., or 50° C. to 150° C., or 90° C. to 300° C., or 90° C. to 150° C., or 120° C. to 300° C., or 150° C. to 300° C.

One potential difficulty with conventional drying methods is that they involve a liquid-gas phase transition for the water purged from the gel. This occurs either whether the conventional drying is performed at ambient pressure or at reduced pressure. Without being bound by any particular theory, allowing the liquid-gas phase transition to occur during the drying process appears to alter the structure, such as by reducing the pore volume and/or surface area that can be achieved in relation to the amount of nitrogen in the organosilica material. It has been discovered that drying using supercritical CO₂ can reduce, minimize, or eliminate this difficulty with the drying process. Freeze drying can also at least partially mitigate the above difficulties with the drying process.

For drying using supercritical CO₂, the drying process is started by first removing water from the intermediate gel using an alcohol, such as methanol or ethanol. After displacing water with alcohol, the gel is rinsed with high pressure liquid CO₂ to remove the alcohol. This leaves behind high pressure liquid CO₂ in the gel structure. The high pressure liquid CO₂ is then removed by increasing the temperature of the CO₂ until the temperature is above the critical point temperature of CO₂. The pressure reduction can be sufficient to remove the CO₂, or a purge with a suitable gas (such as nitrogen) can be performed. This results in the organosilica gel product. By increasing the temperature to above the critical point and then reducing the temperature, no phase transition occurs when changing from the initial high pressure liquid CO₂ to higher temperature, lower pressure CO₂. Avoiding this phase transition allows the CO₂ to be converted into a gas while reducing or minimizing changes to the structure of the gel. It is noted that the critical point for CO₂ is roughly 31° C. and 7.39 MPa.

During a supercritical CO₂ drying process, the initial displacement of water via solvent exchange with alcohol can be performed using any convenient small alcohol or mixture of small alcohols. Examples of suitable alcohols include, but are not limited to, methanol, ethanol, n-propyl alcohol, isopropyl alcohol, C₄ alcohol, and combinations thereof. More generally, the alcohol can correspond to an alcohol (or mixture of alcohols) where the alcohol does not freeze at −57° C., which is the minimum temperature for formation of liquid CO₂. The initial alcohol solvent exchange can be performed at a temperature of 0° C. to 30° C., or 5° C. to 30° C. It is noted that the solvent exchange should be performed at a high enough temperature that the water within the intermediate gel does not freeze. Any convenient pressure can be used for the alcohol solvent exchange. In some aspects, the alcohol solvent exchange can be performed at roughly ambient pressure, so a pressure of roughly 90 kPa-a or more, or 100 kPa-a or more. In other aspects, it can be convenient to perform the alcohol solvent exchange at a pressure that is similar to the pressure that will be used for the initial introduction of liquid CO₂ into the gel. In such aspects, the pressure during the alcohol solvent exchange can be 0.8 MPa-a or higher, or 2.0 MPa-a or higher, or 4.0 MPa-a or higher or 7.4 MPa-a or higher, such as up to 10 MPa-a or possibly still higher. The solvent exchange can be performed for a sufficient amount of time to remove substantially all of the water from the gel structure. In some aspects, the solvent exchange with alcohol can be performed for 0.5 hours to 24 hours, or 1.0 hours to 24 hours, or 0.5 hours to 12 hours, or 1.0 hours to 12 hours. In some aspects, this can correspond to performing a plurality of washes with alcohol, such as up to 5, or up to 10.

After solvent exchange with alcohol, a second wash can be performed with fluid CO₂, such as liquid CO₂ and/or supercritical CO₂. Because the small alcohols used in the alcohol solvent exchange have lower freezing points than water, the gel can be washed with the fluid CO₂ at a temperature between −59° C. and 5.0° C. During the wash with fluid CO₂, the pressure can be any convenient pressure where the CO₂ is in a liquid state (or optionally a supercritical state) based on the temperature. In various aspects, the pressure during the liquid CO₂ wash step can be 0.8 MPa-a or higher, or 2.0 MPa-a or higher, or 4.0 MPa-a or higher or 7.4 MPa-a or higher, such as up to 10 MPa-a or possibly still higher. The wash can be performed for a sufficient amount of time to remove substantially all of the alcohol wash from the gel structure. In some aspects, the wash with fluid CO₂ can be performed for 1.0 hours to 12 hours, or 1.0 hours to 8.0 hours, or 1.0 hours to 4.0 hours, or 2.0 hours to 12 hours, or 2.0 hours to 8.0 hours, or 2.0 hours to 4.0 hours. Optionally, the wash with fluid CO₂ can be performed iteratively, with between 1-3 washes with CO₂ being performed before proceeding to the next step.

After washing with CO₂, the pressure in the wash environment can be increased so that the pressure is above the critical point for CO₂. The corresponds to increasing the pressure to 7.4 MPa-a or more. Higher values of pressure can be used, so long as the pressure does not cause substantial collapse of the gel structure. Thus, pressures of up to 20 MPa-a can be used, although achieving such pressures that are substantially above the critical point incurs additional energy cost with little or no additional benefit. It is noted that the increase in pressure can be performed in any convenient manner, so long as the CO₂ does not undergo a phase transition to a solid or a gas during the increase. It is further noted that if the pressure during the CO₂ was 7.4 MPa-a or higher, then no further pressure increase is needed.

The temperature in the wash environment can also be increased so that the temperature is above the critical point for CO₂. This corresponds to increasing the temperature to 31° C. or more. Higher values of temperature can be used (such as up to 70° C.) although achieving such temperatures that are substantially above the critical point incurs additional energy cost with little or no additional benefit. In some aspects, the increase in pressure and temperature can be performed sequentially, so that the pressure is increased first, and then the temperature is increased. In other aspects, the temperature and pressure increase(s) can be performed in any convenient manner, so long as no phase transition for CO₂ occurs during the increase(s) in temperature and pressure. It is noted that the path to achieving the pressure and temperature combination that is greater than the critical point for CO₂ may include steps where the pressure or temperature are decreased.

After increasing the temperature and/or pressure in the wash environment to a combination of temperature and pressure beyond the CO₂ critical point, the pressure can be decreased while the temperature remains above the critical point so that the CO₂ is in the “gas phase” portion of the phase diagram after decreasing the pressure. Once the pressure in the wash environment is in the “gas phase” portion of the phase diagram, any convenient combination of temperature and/or pressure changes can be used to reduce the density of the CO₂ to a point where the CO₂ can be removed. In some aspects, the CO₂ can be purged with a purge stream (such as N₂ or air). Additionally or alternately, the pressure can be reduced to a pressure below 100 kPa-a, or below 90 kPa-a, such as down to 1.0 kPa-a or possibly still lower, to remove the CO₂ in a vacuum environment. Of course, a combination of a purge gas and a reduced pressure environment can also be used. Still another option is to vent the CO₂, without the need for either a purge or reducing the pressure below 100 kPa-a.

Freeze drying provides an alternative method of trying to avoid a liquid-gas phase transition while removing liquids from the gel structure. Instead of going around the supercritical point, a freeze drying process converts the liquid in the gel to a solid, and then removes the solid via a solid-gas phase transition. There are several options for performing the freeze drying. One option is to directly freeze the water in the gel, and then reduce the pressure in the wash environment to a sufficiently low pressure that the ice sublimates (i.e., passes directly from solid to gas phase). Alternatively, the water can be removed by rinsing with one or more secondary wash mediums, such as small alcohols or CO₂. The temperature and pressure can then be modified so that the secondary wash medium remaining in the gel is converted to a solid, followed by a second modification of the pressure to sublimate the solid to a gas. It is noted that some disruption of the resulting gel structure can still occur during the solid-gas phase transition in the freeze-drying method. After sublimating the wash medium, the gas can be removed from the gel by reducing the pressure to 70 kPa-a or less, or 50 kPa-a or less, such as down to 1.0 kPa-a or possibly still lower. Optionally, a purge gas (such as N₂ or air) can be used to assist with removing the gas from the gel structure.

### Characterization of Organosilica Materials

The organosilica materials made by the methods described herein can be characterized as described in the following sections.

### A. X-Ray Diffraction Peaks

The organosilica materials described herein, prior to grafting, can exhibit powder X-ray diffraction patterns with one broad peak between about 1 and about 4 degrees 2θ, particularly one peak between about 1 and about 3 degrees 2θ. Additionally or alternatively, in the 0.5 to 12 degrees 2θ range, the organosilica materials can exhibit substantially no peaks. The organosilica materials can exhibit substantially no peaks in the range of about 3 to about 12 degrees 2θ, about 4 to about 12 degrees 2θ, in the range of about 5 to about 12 degrees 2θ, in the range of about 6 to about 12 degrees 2θ, in the range of about 7 to about 12 degrees 2θ, in the range of about 8 to about 12 degrees 2θ, in the range of about 9 to about 12 degrees 2θ, in the range of about 10 to about 12 degrees 2θ, or in the range of about 11 to about 12 degrees 2θ.

### B. Pore Size

The pore size of the organosilica materials, both before and after grafting, can vary depending on the nature of the synthesis, including the nature of the drying method. Materials formed using supercritical CO₂ as a drying method can generally be in a mesoporous form. As indicated previously, the term mesoporous refers to solid materials having pores with a diameter within the range of from about 2 nm to about 50 nm. Materials dried by other methods may be in mesoporous form, or the pore average pore size may be as low as 1.0 nm. In this discussion, the average pore diameter of the organosilica material can be determined based on a procedure similar to the procedure in UOP 425, but with an activation procedure that corresponded to exposing the material to a temperature of 140° C. for 4 hours under vacuum prior to obtaining an isotherm. It is noted that this modified version of UOP 425 is used herein even for pore sizes below 1.0 nm. The average pore diameter can be characterized prior to grafting and after grafting.

For materials dried using supercritical CO₂, the organosilica material can have an average pore diameter of 2.0 nm to 50 nm, or 2.0 nm to 20 nm, or 2.0 nm to 10 nm, or 5.0 nm to 50 nm, or 5.0 nm to 20 nm, or 10 nm to 50 nm. In some alternative aspects, the organosilica material can have sufficient micropore volume that the average pore diameter may be less than 2.0 nm. Thus, in some alternative aspects, the organosilica material can have an average pore diameter of 1.2 nm to 20 nm, or 1.2 nm to 10 nm, or 1.2 nm to 5.0 nm, or 1.5 nm to 20 nm, or 1.5 nm to 10 nm, or 1.5 nm to 5.0 nm, or 2.0 nm to 5.0 nm.

More generally, the organosilica material can have an average pore diameter of 0.5 nm to 50 nm, or 0.5 nm to 20 nm, or 0.5 nm to 10 nm, or 1.0 nm to 50 nm, or 1.0 nm to 20 nm, or 2.0 nm to 50 nm, or 2.0 nm to 20 nm, or 2.0 nm to 10 nm, or 5.0 nm to 50 nm, or 5.0 nm to 20 nm, or 10 nm to 50 nm.

### C. Surface Area

The surface area of the organosilica material can be determined, for example, using nitrogen adsorption-desorption isotherm techniques within the expertise of one of skill in the art, such as the BET (Brunauer Emmet Teller) method. This method may determine a total surface area, an external surface area, and a microporous surface area. As used herein, and unless otherwise specified, “total surface area” refers to the total surface area as determined by the BET method. As used herein, and unless otherwise specified, “microporous surface area” refers to microporous surface are as determined by the BET method in ASTM UOP 425, with the modification to the activation procedure (4 hours at 140° C. under vacuum) described above. It is noted that the total surface area prior to grafting will typically be higher than the total surface area after grafting. Without being bound by any particular theory, this is believed to be due to filling of pores by the aminosilane reagent(s) used during grafting. However, by using the grafting method described herein, the loss of surface area is mitigated, so that the organosilica material after grafting still has a substantial surface area.

In various aspects prior to grafting, the organosilica material can have a total surface area of 100 m²/g to about 2,000 m²/g, or 100 m²/g to 1,500 m²/g, or 100 m²/g to 1000 m²/g, or 100 m²/g to 500 m²/g, or 200 m²/g to about 2,000 m²/g, or 200 m²/g to about 1,500 m²/g, or 200 m²/g to 1000 m²/g, or 400 m²/g to about 2,000 m²/g, or 400 m²/g to about 1,500 m²/g, or 400 m²/g to 1000 m²/g, or 600 m²/g to 2,000 m²/g, or 600 m²/g to 1,500 m²/g, or 800 m²/g to 2000 m²/g, or 800 m²/g to 1,500 m²/g. After grafting, the organosilica material can have a total surface area of 50 m²/g to about 1,500 m²/g, or 500 m²/g to about 1,000 m²/g, or 50 m²/g to 500 m²/g, or 100 m²/g to about 1,500 m²/g, or 100 m²/g to about 1,000 m²/g, or 100 m²/g to 500 m²/g, or 200 m²/g to 1,500 m²/g, or 200 m²/g to 1,000 m²/g, or 200 m²/g to 500 m²/g, or 400 m²/g to 1,500 m²/g.

Due to the nature of the grafting process, the total surface area of the grafted organosilica material will typically be lower than the total surface area of the organosilica material prior to grafting. This is due in part to filling of pores during the grafting process. However, the grafting process does allow the organosilica material to retain a substantial amount of total surface area after grafting. This can be characterized as a ratio of total surface area for the grafted organosilica material relative to the total surface area of the organosilica material prior to grafting. Depending on the aspect, the ratio of total surface area for the grafted organosilica material to the total surface area of the organosilica material prior to grafting can be 0.25 or more, or 0.30 or more, or 0.35 or more, such as up to 0.90 or possibly still higher.

### D. Pore Volume

The pore volume of the organosilica material can be determined according to the method in ASTM UOP 425, with the modification to the activation procedure (4 hours at 140° C. under vacuum) described above. It is noted that pore volume is a quantity that tends to decrease after grafting, but the mild grafting conditions described herein can mitigate the loss of pore volume. In various aspects prior to grafting, the organosilica material can have a pore volume of 0.15 cm³/g to 3.0 cm³/g, or 0.15 cm³/g to 2.7 cm³/g, or 0.15 cm³/g to 2.0 cm³/g, or 0.15 cm³/g to 1.0 cm³/g, or 0.35 cm³/g to 3.0 cm³/g, or 0.35 cm³/g to 2.7 cm³/g, or 0.35 cm³/g to 2.0 cm³/g, or 0.35 cm³/g to 1.0 cm³/g, or 0.75 cm³/g to 3.0 cm³/g, or 1.0 cm³/g to 3.0 cm³/g, or 1.5 cm³/g to 3.0 cm³/g, or 2.0 cm³/g to 3.0 cm³/g, or 0.75 cm³/g to 2.7 cm³/g, or 1.0 cm³/g to 2.7 cm³/g, or 1.5 cm³/g to 2.7 cm³/g, or 2.0 cm³/g to 2.7 cm³/g. After grafting, the organosilica material can have a pore volume of 0.07 cm³/g to 1.7 cm³/g, or 0.07 cm³/g to 1.4 cm³/g, or 0.07 cm³/g to 1.0 cm³/g, or 0.40 cm³/g to 1.7 cm³/g, or 0.50 cm³/g to 1.7 cm³/g, or 0.75 cm³/g to 1.7 cm³/g, or 1.0 cm³/g to 1.7 cm³/g, or 0.40 cm³/g to 1.4 cm³/g, or 0.50 cm³/g to 1.4 cm³/g, or 0.75 cm³/g to 1.4 cm³/g, or 1.0 cm³/g to 1.4 cm³/g.

Due to the nature of the grafting process, the pore volume of the grafted organosilica material will typically be lower than the pore volume of the organosilica material prior to grafting. This is due in part to filling of pores during the grafting process. However, the grafting process does allow the organosilica material to retain a substantial amount of pore volume after grafting. This can be characterized as a ratio of pore volume for the grafted organosilica material relative to the pore volume of the organosilica material prior to grafting. Depending on the aspect, the ratio of pore volume for the grafted organosilica material to the pore volume of the organosilica material prior to grafting can be 0.40 or more, or 0.45 or more, or 0.50 or more, or 0.55 or more, such as up to 0.90 or possibly still higher.

### E. Gas Separation Processes—Separation of CO₂ for Carbon Capture

In some aspects, an organosilica material can be used in a gas separation process. The gas separation process can comprise contacting a gas mixture containing at least one contaminant with the organosilica material.

As an example, one type of separation can be a method for abating CO₂ from a flue gas in which the flue gas is contacted with an amine-functionalized organosilica material as described herein to reversibly adsorb CO₂ from the flue gas, capturing >90% by volume, preferably >99% by volume, CO₂ emissions such that the emissions are negative, resulting in direct CO₂ capture from the air, thereby generating an adsorption material enriched for CO₂ and then stripping a major portion of the CO₂ from the adsorption material enriched for CO₂ using a temperature swing adsorption method, vacuum swing adsorption method, a pressure swing adsorption method, a concentration swing adsorption method, or a combination thereof. A typical CO₂ content for air is roughly 400 vppm, or this type of separation corresponds to separating CO₂ from a gas flow having a CO₂ content of 200 vppm to 600 vppm.

Another type of separation can be a method for capturing CO₂ from air, also known as direct air capture, in which air is contacted with an amine-functionalized organosilica material as described herein to reversibly adsorb CO₂ from air, capturing >50% by volume, preferable >75% by volume, CO₂ emissions, or stated differently, reducing CO₂ concentrations in air to less than about 200 ppmv, preferably to less than 100 ppmv, such that the emissions are negative, resulting in direct CO₂ capture from the air, thereby generating an adsorption material enriched for CO₂. It would be understood by a person of skill in the art that as the base concentration changes, the capture rate also changes. A major portion of the CO₂ can then stripped from the adsorption material enriched for CO₂ using a temperature swing adsorption method, vacuum swing adsorption method, a pressure swing adsorption method, a concentration swing adsorption method, or a combination thereof.

Still another type of application is carbon capture from powerplant exhaust, such as coal flue gas. The increasing atmospheric levels of carbon dioxide (CO₂), which are likely contributing to global climate change, warrant new strategies for reducing CO₂ emissions from point sources such as power plants. In particular, coal-fueled power plants are responsible for a substantial portion of global anthropogenic energy supply CO₂ emissions. Thus, there remains a continuing need for the development of new adsorbents for carbon capture from coal flue gas. An example of a gas stream corresponding to a coal flue gas can include CO₂ (˜15-16%), O₂ (˜3-4%), H₂O (˜5-7%), N₂ (˜70-75%), and trace impurities (e.g. SO₂, NOₓ) at ambient pressure and 40° C. For a temperature swing adsorption process for separating CO₂ from a flue gas (such as coal flue gas), it can be beneficial to have an adsorbent that possesses one or more the following properties: (a) a high working capacity with a minimal temperature swing, in order to minimize regeneration energy costs; (b) high selectivity for CO₂ over the other constituents of coal flue gas; (c) 90% (or greater) capture of CO₂ under flue gas conditions; (d) effective performance under humid conditions; and (d) long-term stability to adsorption/desorption cycling under humid conditions.

More generally, another example of a separation can be a method for abating CO₂ from a flue gas, such as natural gas flue gas. Generally, a combustion flue gas can correspond to a gas containing 4.0 vol % or more of CO₂, with higher CO₂ concentrations possible for flue gases formed by burning hydrocarbons other than methane or natural gas, such as coal or heavy oils. In such embodiments, the flue gas is contacted with an amine-functionalized organosilica material as described herein to reversibly adsorb CO₂ from the flue gas thereby generating an adsorption material enriched for CO₂ and then stripping a major portion of the CO₂ from the adsorption material enriched for CO₂ using a using a temperature swing adsorption method, vacuum swing adsorption method, a pressure swing adsorption method, a concentration swing adsorption method, or a combination thereof.

In some aspects, a separation can be used to sequester carbon dioxide produced by a source. In such aspects, a method can include exposing the carbon dioxide to an amine-functionalized organosilica material as described herein whereby the carbon dioxide is reversibly sequestered into the adsorption material. In some such embodiments, the method further comprises regenerating the adsorption material enriched for CO₂ using a temperature swing adsorption method, vacuum swing adsorption method, a pressure swing adsorption method, a concentration swing adsorption method, or a combination thereof.

More generally, in some aspects, an amine-functionalized organosilica material as described herein can be used in a method of sequestering carbon dioxide from a multi-component gas mixture. In such aspects, a multi-component gas mixture can include CO₂ and at least one of N₂, H₂O, and O₂. The multi-component gas mixture is exposed to an amine-functionalized organosilica material as described herein whereby a least fifty percent, at least sixty percent, or at least eighty percent of the carbon dioxide within the multi-component gas mixture is reversibly sequestered into the adsorption material. In some such embodiments, the method further comprises regenerating the adsorption material enriched for CO₂ using a temperature swing adsorption method, vacuum swing adsorption method, a pressure swing adsorption method, a concentration swing adsorption method, or a combination thereof.

F. Gas Separation Processes—Separation of CO₂ from Methane-Containing Gases

Another option for performing a gas separation process is to use a swing adsorption processes, such as pressure swing adsorption (PSA) and temperature swing adsorption (TSA). All swing adsorption processes typically have an adsorption step in which a feed mixture (typically in the gas phase) is flowed over an adsorbent to preferentially adsorb a more readily adsorbed component relative to a less readily adsorbed component. A component may be more readily adsorbed because of kinetic or equilibrium properties of the adsorbent. The adsorbent (e.g., the organosilica material described herein) can typically be contained in a contactor that is part of the swing adsorption unit. The contactor can typically contain an engineered structured adsorbent bed or a particulate adsorbent bed. The bed can contain the adsorbent (e.g., the organosilica material described herein) and other materials such as other adsorbents, mesopore filling materials, and/or inert materials used to mitigated temperature excursions from the heat of adsorption and desorption. Other components in the swing adsorption unit can include, but are not necessarily limited to, valves, piping, tanks, and other contactors. Examples of swing adsorption processes are described in detail in, for example, U.S. Pat. Nos. 8,784,533; 8,784,534; 8,858,683; and 8,784,535. Examples of processes that can be used herein either separately or in combination are PSA, TSA, pressure temperature swing adsorption (PTSA), partial purge displacement swing adsorption (PPSA), PPTSA, rapid cycle PSA (RCPSA), RCTSA, RCPPSA and RCPTSA.

Swing adsorption processes can be applied to remove a variety of target gases, also referred to as “contaminant gas” from a wide variety of gas mixtures. Typically, in binary separation systems, the “light component” as utilized herein is taken to be the species or molecular component(s) not preferentially taken up by the adsorbent in the adsorption step of the process. Conversely in such binary systems, the “heavy component” as utilized herein is typically taken to be the species or molecular component(s) preferentially taken up by the adsorbent in the adsorption step of the process. However, in binary separation systems where the component(s) that is(are) preferentially adsorbed has(have) a lower molecular weight than the component(s) that is(are) not preferentially adsorbed, those descriptions may not necessarily correlate as disclosed above.

An example of gas mixture that can be separated in the methods described herein is a gas mixture comprising CH₄, such as a natural gas stream. A gas mixture comprising CH₄ can contain significant levels of contaminants such as H₂O, H₂S, CO₂, N₂, mercaptans, and/or heavy hydrocarbons. Additionally or alternatively, the gas mixture can comprise NOₓ and/or SOₓ species as contaminants, such as a waste gas stream, a flue gas stream and a wet gas stream. As used herein, the terms “NOₓ,” and “NOₓ” species refers to the various oxides of nitrogen that may be present in waste gas, such as waste gas from combustion processes. The terms refer to all of the various oxides of nitrogen including, but not limited to, nitric oxide (NO), nitrogen dioxide (NO₂), nitrogen peroxide (N₂O), nitrogen pentoxide (N₂O₅), and mixtures thereof. As used herein, the terms “SOₓ,” and “SOₓ species,” refers to the various oxides of sulfur that may be present in waste gas, such as waste gas from combustion processes. The terms refer to all of the various oxides of sulfur including, but not limited to, SO, SO₂, SO₃, SO₄, S₇O₂ and S₆O₂. Thus, examples of contaminants include, but are not limited to H₂O, H₂S, CO₂, N₂, mercaptans, heavy hydrocarbons, NOₓ and/or SOₓ species. In particular, the gas mixture may comprise CH₄ and the at least one contaminant is CO₂ and/or H₂S.

An example of a method for separating CO₂ from a methane-containing stream is removing CO₂ from a biogas. The method comprises contacting the biogas with an amine-functionalized organosilica material as described herein to reversibly adsorb CO₂ from the biogas thereby generating an adsorption material enriched for CO₂ and a residual gas that is greater than 98 percent pure methane. In some such embodiments, the method further comprises stripping a major portion of the CO₂ from the adsorption material enriched for CO₂ using a temperature swing adsorption method, vacuum swing adsorption method, a pressure swing adsorption method, a concentration swing adsorption method, or a combination thereof.

Another example of a method for separating CO₂ from a methane-containing stream is removing CO₂ from a hydrocarbon reservoir. The method comprises contacting the hydrocarbon reservoir with an amine-functionalized organosilica material as described herein to reversibly adsorb CO₂ from the hydrocarbon reservoir thereby generating an adsorption material enriched for CO₂. In some such embodiments, the method further comprises stripping a major portion of the CO₂ from the adsorption material enriched for CO₂ using a temperature swing adsorption method, vacuum swing adsorption method, a pressure swing adsorption method, a concentration swing adsorption method, or a combination thereof.

In various aspects, a process for selectively separating a contaminant from a feed gas mixture is provided herein. The process may comprise: a) contacting the feed gas mixture under sorption conditions with organosilica material described herein; b) adsorbing the contaminant into/onto the organosilica material described herein; c) subjecting the organosilica material described herein to desorption conditions by which at least a portion of the sorbed contaminant is desorbed; and d) retrieving a contaminant-rich product stream that has a higher mol % of contaminant than the feed gas mixture. The feed gas mixture may be any of the gas mixtures described above. Particularly, the feed gas mixture may comprise CH₄. The contaminant may be any of the contaminants described above, e.g., CO₂, H₂S, etc.

The provided processes and apparatuses may be used to prepare natural gas products by removing contaminants. The provided processes and apparatuses can be useful for preparing gaseous feed streams for use in utilities, including separation applications such as dew point control, sweetening/detoxification, corrosion protection/control, dehydration, heating value, conditioning, and purification. Examples of utilities that utilize one or more separation applications can include generation of fuel gas, seal gas, non-potable water, blanket gas, instrument and control gas, refrigerant, inert gas, and hydrocarbon recovery. Exemplary “not to exceed” product (or “target”) acid gas removal specifications can include: (a) 2 vol % CO₂, 4 ppm H₂S; (b) 50 ppm CO₂, 4 ppm H₂S; or (c) 1.5 vol % CO₂, 2 ppm H₂S.

The provided processes and apparatuses may also be used to remove acid gas from hydrocarbon streams. Acid gas removal technology becomes increasingly important as remaining gas reserves exhibit higher concentrations of acid (sour) gas resources. Hydrocarbon feed streams can vary widely in amount of acid gas, such as from several parts per million to 90 vol %. Non-limiting examples of acid gas concentrations from exemplary gas reserves can include concentrations of at least: (a) 1 vol % H₂S, 5 vol % CO₂; (b) 1 vol % H₂S, 15 vol % CO₂; (c) 1 vol % H₂S, 60 vol % CO₂; (d) 15 vol % H₂S, 15 vol % CO₂; or (e) 15 vol % H₂S, 30 vol % CO₂.

### G. CO₂ Capacity and Amine Utilization

Still another option for characterizing amine-functionalized and/or dual-functionalized organosilica materials is based on the CO₂ capacity of the material. One example of a way to characterize a material based on CO₂ capacity is determining a maximum CO₂ capacity under a specified set of conditions. Another example is amine utilization, which compares the maximum CO₂ capacity of a material at a set of conditions with the number of amines (potential sorption locations) contained in the material.

For CO₂ capacity, a set of standard conditions for determining the CO₂ capacity of a material is to determine an equilibrium capacity in an atmosphere that is 100% CO₂ at a pressure of 0.04 atm (˜40 kPa) at 30° C. When determining an isotherm, this would correspond to a P/PO value of 0.04, where PO is 1.0 atm (˜100 kPa). As preparation for the determination of equilibrium capacity, the material is first activated for 4 hours under vacuum at a temperature of 140° C. In various aspects, the organosilica material, prior to grafting, has a CO₂ capacity of greater than 1.0 mmol CO₂/g organosilica material in an environment comprising 4.0 vol % CO₂ at 30° C., or greater than 1.2 mmol CO₂/g organosilica material, or greater than 1.2 mmol CO₂/g organosilica material, or greater than 1.2 mmol CO₂/g organosilica material, such as up to 2.5 mmol CO₂/g organosilica material or possibly still higher. After grafting, the CO₂ capacity can be similar or higher. For the grafted material, the material can have a CO₂ capacity of greater than 1.0 mmol CO₂/g organosilica material in an environment comprising 4.0 vol % CO₂ at 30° C., or greater than 1.2 mmol CO₂/g organosilica material, or greater than 1.2 mmol CO₂/g organosilica material, or greater than 1.2 mmol CO₂/g organosilica material, such as up to 2.5 mmol CO₂/g organosilica material or possibly still higher.

For amine utilization, the amine utilization is defined as the molar ratio of CO₂ sorbed by the organosilica material to the nitrogen in the organosilica material at equilibrium for a CO₂ pressure of 1.0 atm (˜100 kPa) and at 30° C. In various aspects, the organosilica material, either prior to or after grafting, has an amine utilization of 0.2 or more, or 0.3 or more, such as up to 0.6 or possibly higher.

### Examples—General Methods

CO₂ adsorption work was done with a Quantchrome Autosorb iQ2. All the samples were pre-treated at 140° C. in vacuum for 4 hours before collecting the CO₂ isotherm at different temperatures.

The nitrogen adsorption/desorption analyses was performed with different instruments, e.g. TriStar 3000, TriStarII 3020 and Autosorb-1. All the samples were pre-treated at 140° C. in vacuum for 4 hours before collecting the N₂ isotherm. The analysis program calculated the experimental data and report BET surface area (total surface area), microporous surface area (S), total pore volume, pore volume for micropores, average pore diameter (or radius), etc.

### Examples—Characterization of Organosilica Materials

The organosilica materials in these examples were made using the method illustrated in FIG. 4. As shown in FIG. 4, the alkoxy-substituted cyclic organosilane “3R” was combined with one of the amine-functionalized organosilanes shown in FIG. 4, optionally along with one of the gellators. The molar ratios of the components for the condensation to make the gel were 1:0.5-3.0:0-0.5 for 3R:amine-functionalized organosilane:gellator. Sufficient base was also added to bring the pH of the condensation mixture to roughly 12.5. The condensation mixture was then stirred at room temperature overnight. The resulting sol was then heated in an autoclave (rotating or stationary) at 90° C. overnight to form the gel.

At this point, one of several drying methods was used to form the final organosilica material. Gel samples were dried using supercritical CO₂ drying, freeze-drying, or by heating up to 120° C. at a pressure below 80 kPa-a (representative of conventional drying conditions for many types of organosilica gels).

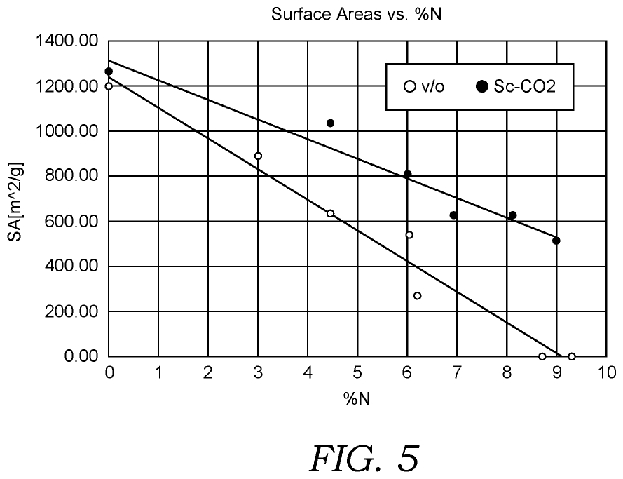

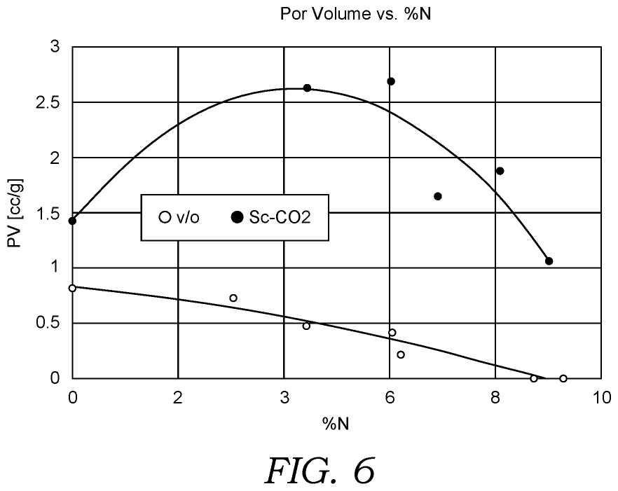

The organosilica materials produced using the various drying methods were then characterized. FIG. 5 shows surface area versus nitrogen content for materials formed using supercritical CO₂ for drying and materials formed using conventional vacuum drying conditions. FIG. 6 shows pore volume versus nitrogen content for the same materials. As shown in FIG. 5, the organosilica materials formed using conventional drying have a much more rapid drop-off in surface area as nitrogen content decreases. By contrast, the organosilica materials formed using supercritical CO₂ during drying had a surface area of 600 m²/g or higher for nitrogen contents up to roughly 8.0 wt %.

As shown in FIG. 6, drying with supercritical CO₂ resulted in materials that also had higher pore volume relative to the nitrogen content. For conventionally dried materials, the pore volume drops monotonically as nitrogen content increased. This is the expected, conventional result. By contrast, relative to the baseline organosilica with no nitrogen content, pore volume actually increased for supercritically dried materials with nitrogen contents of roughly 8.0 wt % or less.

Without being bound by any particular theory, it is believed that by avoiding liquid-gas phase transitions during the drying process, the amount of damage to a gel structure can be reduced, thereby preserving an increased amount of surface area and/or pore volume.

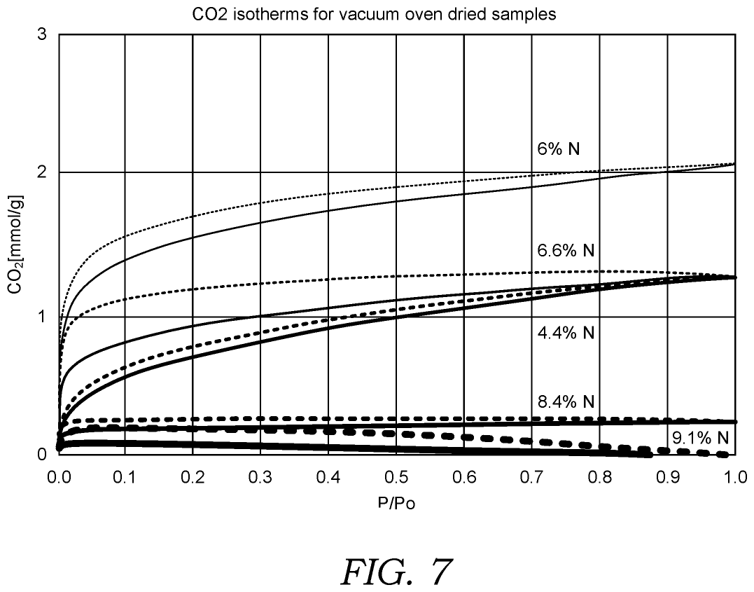

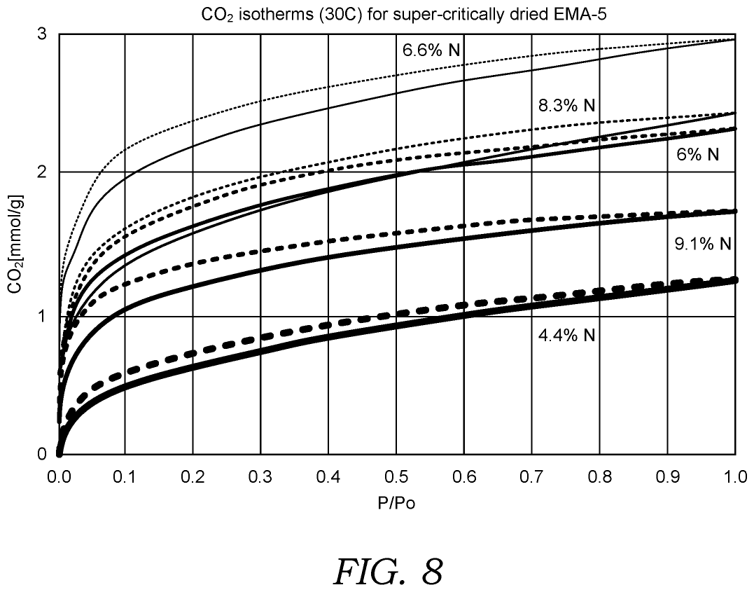

It has been discovered that the structural differences caused by different drying methods result in different sorption behavior for the resulting organosilica materials. FIG. 7 shows CO₂ isotherms at 30° C. for organosilica materials formed using a conventional drying method. FIG. 8 shows CO₂ isotherms for organosilica materials formed using supercritical CO₂ drying.

As shown in FIG. 7, the CO₂ sorption capacity for organosilica materials dried in a conventional manner is a trade-off between increasing the nitrogen content to provide additional sorption sites versus the decreases in surface area and/or pore volume that reduce the availability of the sorption sites. In FIG. 7, for organosilica materials dried in a conventional manner, CO₂ sorption capacity increases with increasing nitrogen content until roughly 6.0 wt % nitrogen content in the organosilica material. After that, further increases in nitrogen content result in decreased CO₂ sorption capacity. Additionally, the CO₂ capacity reaches a maximum at around 2.0 mmol CO₂/g sorbent.

FIG. 8 illustrates the unexpected benefits of using supercritical CO₂ drying for organosilica materials. As shown in FIG. 8, the maximum in CO₂ sorption capacity is not reached until the organosilica material having a nitrogen content of 6.6 wt %. Additionally, for the conventional materials in FIG. 7, the maximum CO₂ sorption capacity was roughly 2.0 mmol CO₂/g sorbent. For the materials formed using supercritical CO₂ drying, the maximum sorption capacity was greater than 2.0 mmol CO₂/g sorbent for nitrogen contents between 6.0 wt % and 8.5 wt %.

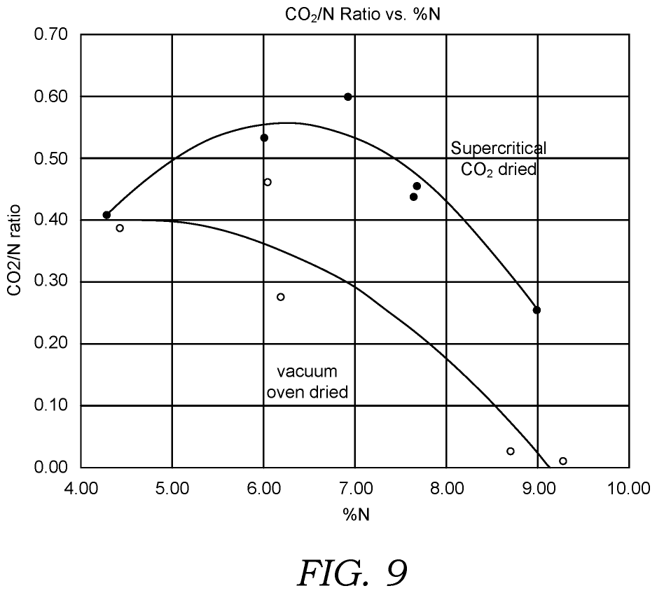

Based in part on the increased surface area and pore volume, the organosilica materials formed using supercritical CO₂ drying also provide an increase in CO₂ utilization during sorption. Based on the nature of the binding interaction, a CO₂/N ratio of 0.5 corresponds to full loading of the binding sites with CO₂. FIG. 9 shows the ratio of CO₂ to N at maximum loading for various organosilicas at maximum loading. As shown in FIG. 9, the highest ratio of CO₂ to N at maximum loading for the conventional organosilicas occurs at the minimum level of N in the organosilica material. By contrast, when using supercritical CO₂ drying, increased ratios of CO₂ to N can be achieved at maximum loading for nitrogen contents between 4.0 wt % and 8.5 wt % in the organosilica materials.

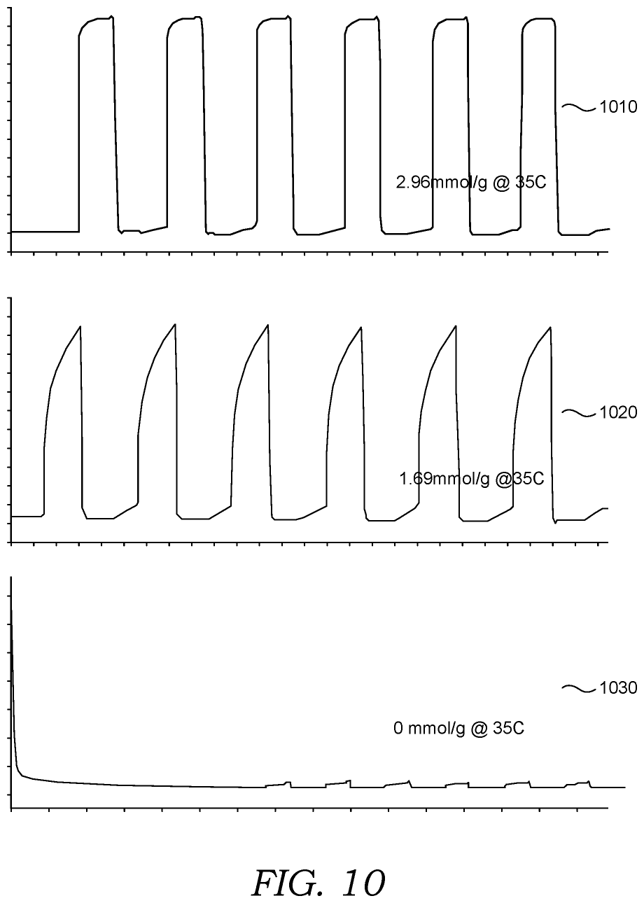

To further illustrate the differences in various drying techniques, FIG. 10 shows CO₂ capacity results for a series of gels formed from the same initial hydrogel. For the samples in FIG. 10, an initial hydrogel was formed having a nitrogen content of roughly 9.0 wt %. The hydrogel was then divided into three parts. A first part was dried using supercritical CO₂, a second part was freeze-dried, while the third part was dried conventionally. The CO₂ adsorption capacity of all three dried samples was measured by thermogravimetric analysis in 80% CO₂/N₂ at 35° C. The samples were first pre-dried at 140° C. in flowing nitrogen for three hours to achieve constant weight, then cooled to 35° C. before introducing CO₂ for 30 minutes, then heating rapidly to 120° C. in flowing nitrogen and holding for 30 minutes. Subsequent repeat of this temperature-programmed cycling for a total of six cycles produced the plots shown in FIG. 10.

FIG. 10 shows the CO₂ sorption for each type of gel during a series of cycles of exposing the organosilica to CO₂ and then desorbing/purging the CO₂. In FIG. 10, data plot 1010 shows that the highest CO₂ sorption capacities were achieved (roughly 3.0 mmol CO₂/g sorbent) when supercritical CO₂ drying was used. The organosilica corresponding to plot 1010 also had the highest surface area (331 m²/g) and pore volume (0.84 cm³/g). Freeze-drying (data plot 1020) provided an intermediate levels of sorption (roughly 1.7 mmol CO₂/g sorbent). The freeze-dried sample had a surface area of 117 m²/g and a pore volume of roughly 0.08 cm³/g. As shown in plot 1030, at roughly 9.0 wt % nitrogen content, the organosilica gels dried using conventional methods had substantially no CO₂ sorption. The conventionally dried sample had the lowest surface area (roughly 8 m²/g) and lowest pore volume (0.01 cm³/g).

The benefits of using supercritical CO₂ for drying were maintained when using different types of amine-functionalizing agents. In the examples presented so far, N-(aminoethyl)aminopropyl trialkoxysilane (“TDA”) was used as the aminosilane precursor functionalizing agent. Similar results were obtained when using two other types of aminosilane functionalizing agents, corresponding to N-(aminohexyl)aminopropyl trialkoxysilane (“C3C6DA”) and N-(aminohexyl)aminomethyl trialkoxysilane (“C1C6DA”)

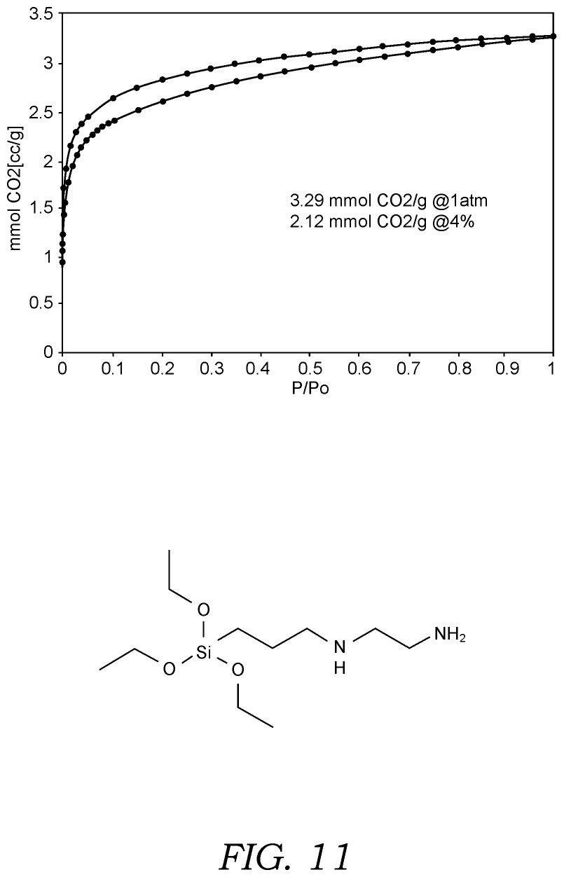

FIGS. 11 to 13 show CO₂ adsorption isotherms for organosilica materials formed using three different types of aminosilane precursors, but at constant nitrogen weight across the organosilica materials. The isotherms were obtained using gas flows corresponding to 100% CO₂ at varying pressures and measuring the CO₂ capacity at each pressure point from ˜0.05% of an atm (˜0.05 kPa-a) to 1 atm (˜100 kPa-a). The aminosilane precursor used in each organosilica material is shown below the corresponding isotherm.

To make the organosilica materials for FIGS. 11 to 13, three sols using the same 3R:aminosilane molar ratio of 1:1.5 were formed in the same overall concentration in pH 10.5 NH₄OH. After overnight stirring at room temperature, the sols with C3C6DA and C1C6DA had already gelled, while the TDA sol remained fluid and was transferred to an autoclave for heating to 90° C. for two days followed by 120° C. for four hours to produce an opaque gel. All three gels were washed 3 times with ethanol then dried in super-critical CO₂. These results indicate the versatility of the synthesis procedure disclosed here to variation in the aminosilane precursor, as well as the ability to achieve high CO₂ adsorption capacity using amine precursors of very different gel-forming characteristics.

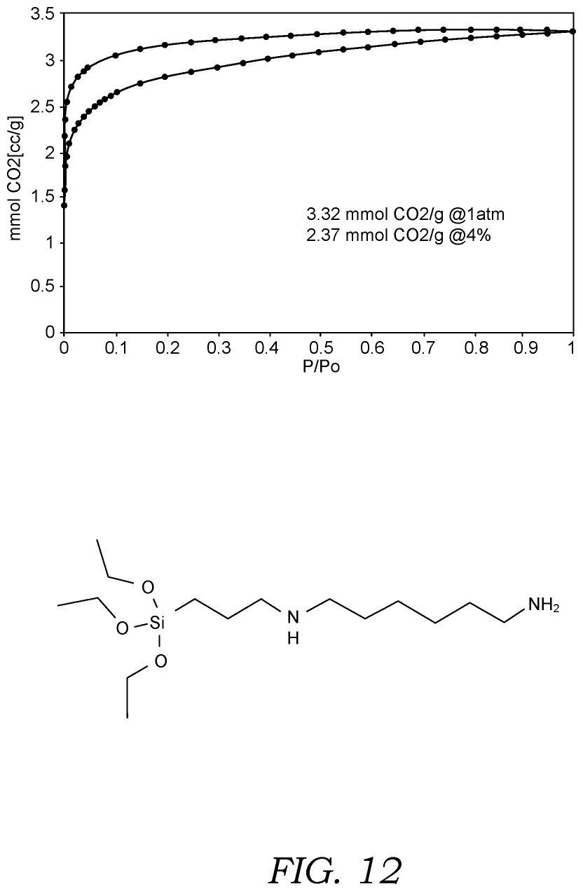

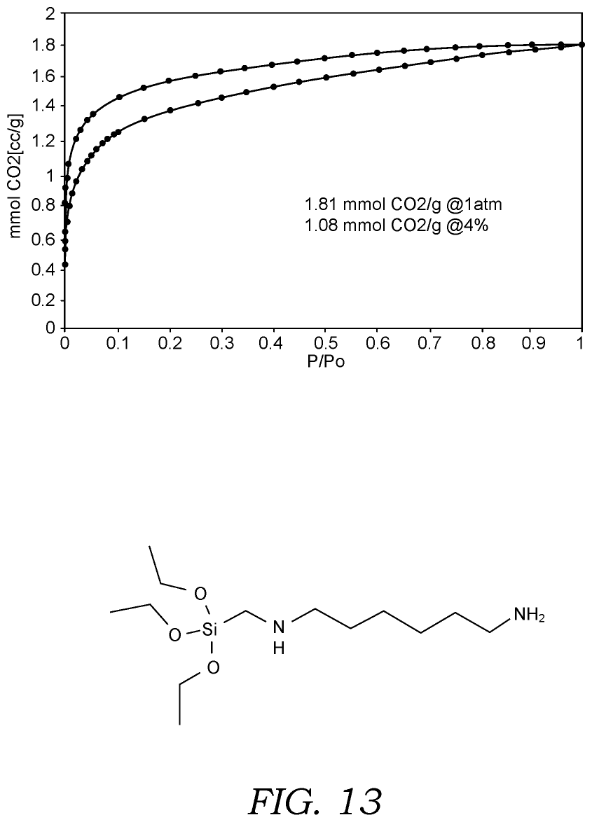

FIG. 11 corresponds to adsorption isotherms for an organosilica material formed using TDA, similar to the examples above. FIG. 12 and FIG. 13 correspond to other types of aminosilane precursors. As shown in FIGS. 11 to 13, at constant nitrogen content in the organosilica material, various types of aminosilane precursors can be used while still maintaining a relatively high capacity for CO₂ adsorption.

### Examples—Grafting of Aminosilane Reagents

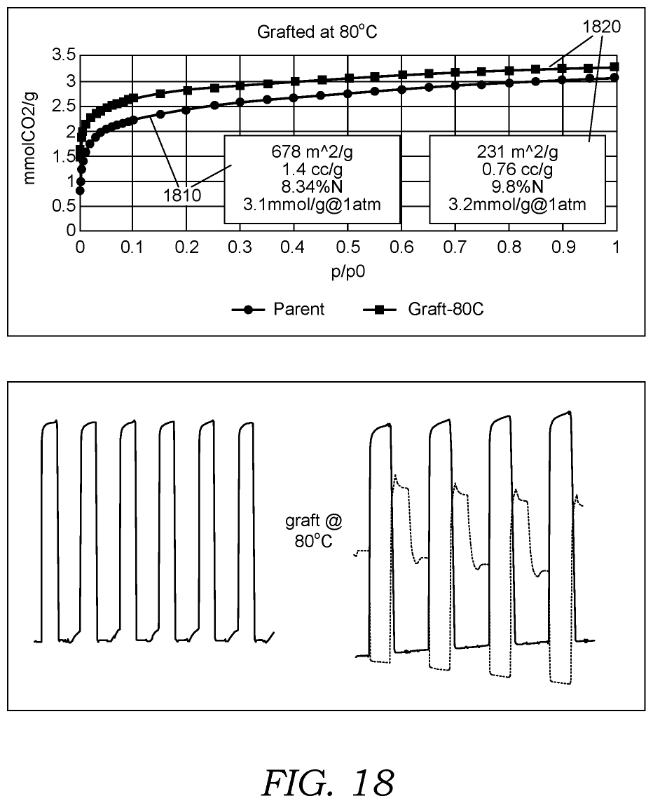

A dual-functionalized organosilica was prepared according to the reaction scheme shown in FIG. 17, with N-(aminoethyl)aminopropyl trialkoxysilane as the aminosilane reagent for the initial synthesis of the organosilica material (prior to grafting). The N-(aminoethyl)aminopropyl trialkoxysilane was also used as the reagent for the subsequent grafting to form the grafted material. The CO₂ sorption capacity of both the organosilica material (prior to grafting) and the dual-functionalized material (after grafting) were characterized. FIG. 18 shows results from the characterization.

The top graph in FIG. 18 shows CO₂ sorption isotherms at 30° C. for the organosilica prior to grafting (line 1810) and the material after grafting (line 1820). The top graph area also includes insets containing other characterization information for the material before and after grafting. As shown in FIG. 18, prior to grafting, the organosilica material 1810 was able to absorb a substantial amount of CO₂, with a CO₂ capacity of 3.1 mmol/g organosilica at 1 atm (˜100 kPa) of CO₂. Prior to grafting, the material 1810 had a surface area of 678 m²/g, a pore volume of 1.4 m³/g, and a nitrogen content of 8.34 wt %. After grafting, the resulting material 1820 has an increased nitrogen content of 9.8 wt %. It is noted that the grafting process reduced the surface area to 231 m²/g and reduced the pore volume to 0.76 m³/g. However, the CO₂ isotherm for the grafted material consistently showed a higher capacity, with a CO₂ capacity of 3.2 mmol/g organosilica at ˜100 kPa of CO₂. This shows that even though the grafting process reduced the pore volume and surface area, and even though the material prior to grafting had a substantial CO₂ sorption capacity, the grafted material still provided a higher CO₂ sorption capacity. It is unexpected that the grafted material would be able to provide increased CO₂ sorption capacity after the substantial reduction in pore volume and surface area that occurred due to the grafting process.

The lower portion of FIG. 18 shows weight gain and loss during successive cycling of temperature between 35° C. and 120° C. in the presence of an atmosphere containing 100% CO₂ during adsorption at 35° C., and 100% N₂ during desorption at 120° C. The pressure of the atmosphere during both desorption and adsorption was roughly 100 kPa-a. The initial half of the lower portion shows weight gain and loss for a sample of the organosilica material prior to grafting, while the latter half of the lower portion shows weight gain and loss for a sample after the grafting procedure. As shown in the lower portion of FIG. 18, for the materials both before and after grafting, the materials substantially retain their CO₂ capacity over multiple cycles of sorption and desorption. It is further noted that both materials rapidly reach close to their maximum CO₂ sorption capacity, as opposed to having an asymptotic approach.

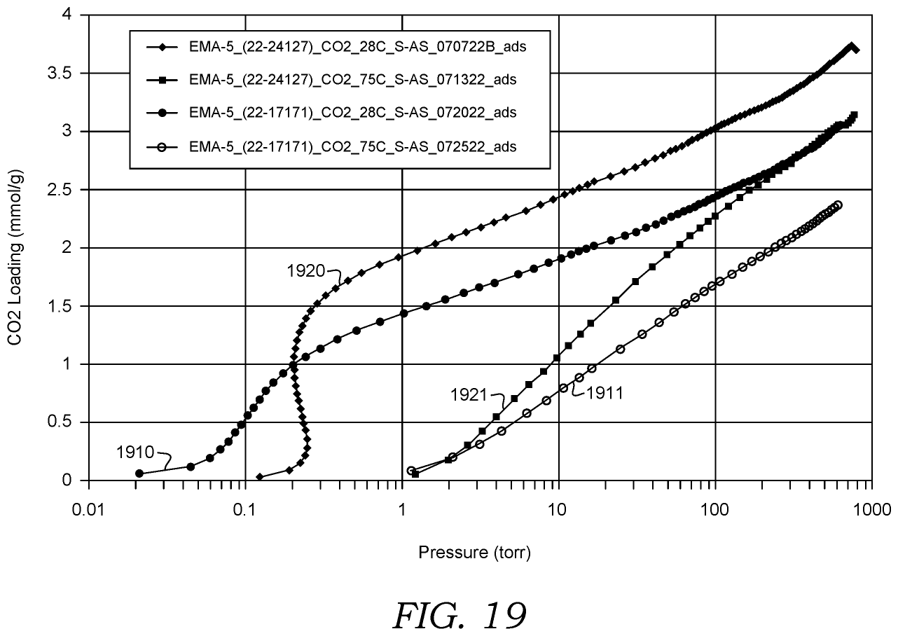

FIG. 19 shows CO₂ for additional samples before and after grafting at temperatures of 28° C. and 75° C. In FIG. 19, lines 1910 and 1911 correspond to materials without grafting, while lines 1920 and 1921 correspond to materials after grafting. Lines 1910 and 1920 correspond to CO₂ loading at 28° C., while lines 1911 and 1921 correspond to CO₂ loading at 75° C.

As shown in FIG. 19, at 28° C., the grafted material 1920 provides a 40% increase in CO₂ capacity relative to the ungrafted material 1910 at 0.3 torr. This is representative of the CO₂ concentration in air, indicating that the grafted material can provide advantages in direct air capture processes. Additionally, the grafted material 1920 provides a roughly 25% increase in CO₂ capacity relative to the ungrafted material 1910 at 30 torr, which roughly corresponds to the CO₂ partial pressure of a natural gas combustion stream. More generally, the grafted material provides higher CO₂ capacity across a wide range of CO₂ partial pressures at both 28° C. and 75° C. It is noted that the enthalpy of sorption or bonding for CO₂ for both the grafted and ungrafted materials are roughly the same.

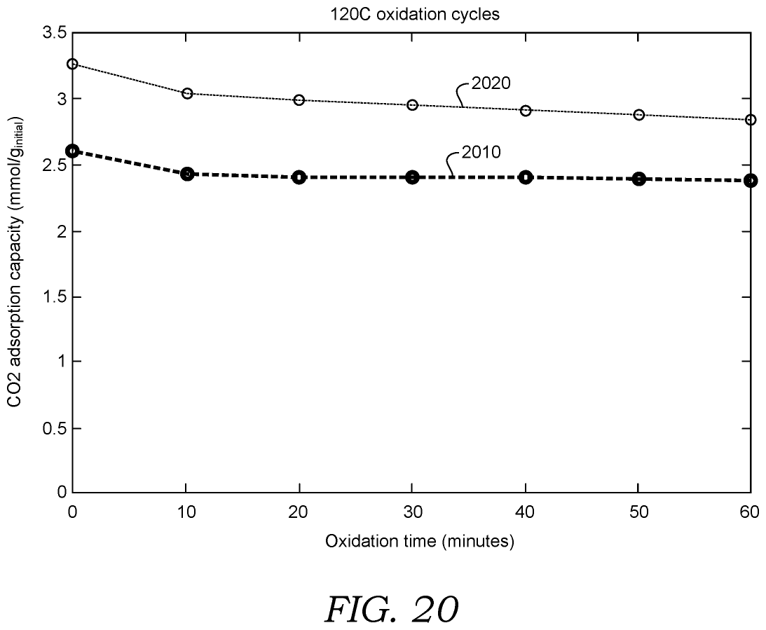

In addition to providing improved CO₂ sorption capacity, the grafted amine samples retain the resistance to air oxidation provided by the organosilica materials prior to grafting. FIG. 20 shows capacity retention for a sample 2010 prior to grafting and a sample 2020 after grafting during cycles of sorption and desorption when exposed to air. The cycles were 10 minutes long, and corresponded to exposure to air at roughly ambient temperature for sorption followed by desorption at 120° C. As shown in FIG. 20, both materials substantially maintained their CO₂ capacity after multiple cycles.

### Additional Embodiments

Embodiment 1. A method for making a grafted organosilica material, comprising: providing an organosilica material comprising a polymer of at least one repeat unit of Formula (1),

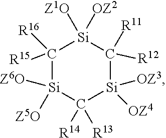

the organosilica material having a nitrogen content of 2.0 wt % to 9.5 wt %, a surface area of 100 m²/g or more, and a pore volume of 0.15 cm³/g or more; forming a suspension of the organosilica material in a solvent; and exposing at least a portion of the suspension of organosilica material to one or more aminosilane precursors under grafting conditions to form a grafted organosilica material, wherein Z¹, Z², Z³, Z⁴, Z⁵, and Z⁶ each independently represent a hydrogen atom, a C₁-C₄ alkyl group, a bond to a silicon atom of another repeat unit of Formula (1), a bond to an aminosilyl group, a bond to a silicon atom that is bonded to three alkoxy groups, or a bond to a silicon atom of a secondary repeat unit, the secondary repeat unit optionally comprising an acyclic alkoxy silane, and wherein R¹¹, R¹², R¹³, R¹⁴, R¹⁵, and R¹⁶ each independently represent a hydrogen atom or a C₁-C₄ alkyl group, wherein a nitrogen content of the grafted organosilica material is higher than the nitrogen content of the organosilica material by 0.5 wt % or more, a ratio of a surface area of the grafted organosilica material to the surface area of the organosilica material is 0.25 or higher, and a ratio of a pore volume of the grafted organosilica material to the pore volume of the organosilica material is 0.4 or higher.

Embodiment 2. The method of Embodiment 1, wherein the one or more aminosilane precursors are selected from the group consisting of N-(aminoalkyl)aminoalkyl polyalkoxysilanes, aminosilanes containing only a single nitrogen, trialkoxysilanes, or a combination thereof, the aminoalkyl groups in the one or more aminosilane precusors optionally comprising C₁-C₆ aminoalkyl groups.

Embodiment 3. The method of any of the above embodiments, the method further comprising forming the organosilica material, the forming comprising: condensing an alkoxy-substituted cyclic organosilane in the presence of at least one aminosilane precursor to form a gel intermediate; and drying the gel intermediate.

Embodiment 4. The method of Embodiment 3, wherein the alkoxy-substituted cyclic organosilane is condensed in the presence of at least one aminosilane precursor and a) a gelator, b) one or more additional precursors that form one or more secondary repeat units during the condensation, or c) a combination of a) and b).

Embodiment 5. The method of Embodiment 3 or 4, wherein drying the gel intermediate comprises using a supercritical CO₂ drying process, a freeze drying process, a drying process performed at a pressure of 80 kPa-a or less, or a combination thereof.

Embodiment 6. The method of any of the above embodiments, wherein the nitrogen content of the organosilica material is 3.0 wt % to 9.5 wt %, or wherein the nitrogen content of the organosilica material is 2.0 wt % to 6.5 wt %.

Embodiment 7. The method of any of the above embodiments, wherein the organosilica material comprises a surface area of 200 m²/g or more, preferably 300 m²/g or more; or wherein the organosilica material comprises a pore volume of 0.35 cm³/g or more, preferably 0.75 cm³/g or more; or a combination thereof.

Embodiment 8. The method of any of the above embodiments, i) wherein the nitrogen content of the grafted organosilica material is higher than the nitrogen content of the organosilica material by 1.0 wt % or more; ii) wherein the ratio of a surface area of the grafted organosilica material to the surface area of the organosilica material is 0.30 or higher; iii) wherein a ratio of a pore volume of the grafted organosilica material to the pore volume of the organosilica material is 0.5 or higher; or iv) a combination of two or more of i), ii), and iii).

Embodiment 9. The method of any of the above embodiments, wherein the solvent is toluene.

Embodiment 10. The method of any of the above embodiments, wherein the organosilica material comprises a CO₂ capacity of greater than 1.0 mmol CO₂/g organosilica material in an environment comprising 4.0 vol % CO₂ at 30° C., preferably greater than 1.2 mmol CO₂/g grafted organosilica material.

Embodiment 11. The method of any of the above embodiments, wherein the organosilica material, at maximum CO₂ capacity, has an amine utilization of greater than 0.30, the amine utilization defined as the molar ratio of CO₂ sorbed by the organosilica material to the nitrogen in the organosilica material.

Embodiment 12. The method of Embodiment 11, wherein the grafted organosilica material, at maximum CO₂ capacity, has an amine utilization of greater than 0.30, the amine utilization defined as the molar ratio of CO₂ sorbed by the grafted organosilica material to the nitrogen in the grafted organosilica material.

Embodiment 13. The method of any of the above embodiments, wherein R¹¹, R¹², R¹³, R¹⁴, R¹⁵, and R¹⁶ each represent a hydrogen atom.

All numerical values within the detailed description and the claims herein are modified by “about” or “approximately” the indicated value, and take into account experimental error and variations that would be expected by a person having ordinary skill in the art.

While the present invention has been described and illustrated by reference to particular embodiments, those of ordinary skill in the art will appreciate that the invention lends itself to variations not necessarily illustrated herein. For this reason, then, reference should be made solely to the appended claims for purposes of determining the true scope of the present invention.

What is claimed is:

1. A method for making a grafted organosilica material, comprising:
providing an organosilica material comprising a polymer of at least one repeat unit of Formula (1), 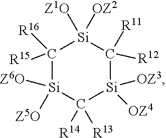
the organosilica material having a nitrogen content of 2.0 wt % to 9.5 wt %, a surface area of 100 m²/g or more, and a pore volume of 0.15 cm³/g or more;
forming a suspension of the organosilica material in a solvent; and
exposing at least a portion of the suspension of organosilica material to one or more aminosilane precursors under grafting conditions to form a grafted organosilica material,
wherein Z¹, Z², Z³, Z⁴, Z⁵, and Z⁶ each independently represent a hydrogen atom, a C₁-C₄ alkyl group, a bond to a silicon atom of another repeat unit of Formula (1), a bond to an aminosilyl group, a bond to a silicon atom that is bonded to three alkoxy groups, or a bond to a silicon atom of a secondary repeat unit, the secondary repeat unit optionally comprising an acyclic alkoxy silane, and
wherein R¹¹, R¹², R¹³, R¹⁴, R¹⁵, and R¹⁶ each independently represent a hydrogen atom or a C₁-C₄ alkyl group,
wherein a nitrogen content of the grafted organosilica material is higher than the nitrogen content of the organosilica material by 0.5 wt % or more, a ratio of a surface area of the grafted organosilica material to the surface area of the organosilica material is 0.25 or higher, and a ratio of a pore volume of the grafted organosilica material to the pore volume of the organosilica material is 0.4 or higher.

2. The method of claim 1, wherein the one or more aminosilane precursors are selected from the group consisting of N-(aminoalkyl)aminoalkyl polyalkoxysilanes, aminosilanes containing only a single nitrogen, trialkoxysilanes, or a combination thereof.

3. The method of claim 2, wherein aminoalkyl groups in the one or more aminosilane precusors comprise C₁-C₆ aminoalkyl groups.

4. The method of claim 1, the method further comprising forming the organosilica material, the forming comprising:
condensing an alkoxy-substituted cyclic organosilane in the presence of at least one aminosilane precursor to form a gel intermediate; and
drying the gel intermediate.

5. The method of claim 4, wherein the alkoxy-substituted cyclic organosilane is condensed in the presence of at least one aminosilane precursor and a) a gelator, b) one or more additional precursors that form one or more secondary repeat units during the condensation, or c) a combination of a) and b).

6. The method of claim 4, wherein drying the gel intermediate comprises using a supercritical CO₂ drying process, a freeze drying process, a drying process performed at a pressure of 80 kPa-a or less, or a combination thereof.

7. The method of claim 1, wherein the nitrogen content of the organosilica material is 3.0 wt % to 9.5 wt %, or wherein the nitrogen content of the organosilica material is 2.0 wt % to 6.5 wt %.

8. The method of claim 1, wherein the organosilica material comprises a surface area of 200 m²/g or more, or wherein the organosilica material comprises a pore volume of 0.35 cm³/g or more, or a combination thereof.

9. The method of claim 1, wherein the organosilica material comprises a surface area of 300 m²/g or more, or wherein the organosilica material comprises a pore volume of 0.75 cm³/g or more, or a combination thereof.

10. The method of claim 1, i) wherein the nitrogen content of the grafted organosilica material is higher than the nitrogen content of the organosilica material by 1.0 wt % or more; ii) wherein the ratio of a surface area of the grafted organosilica material to the surface area of the organosilica material is 0.30 or higher; iii) wherein a ratio of a pore volume of the grafted organosilica material to the pore volume of the organosilica material is 0.5 or higher; or iv) a combination of two or more of i), ii), and iii).

11. The method of claim 1, wherein the solvent is toluene.

12. The method of claim 1, wherein the organosilica material comprises a CO₂ capacity of greater than 1.0 mmol CO₂/g organosilica material in an environment comprising 4.0 vol % CO₂ at 30° C.

13. The method of claim 12, wherein the grafted organosilica material comprises a CO₂ capacity of greater than 1.2 mmol CO₂/g grafted organosilica material in an environment comprising 4.0 vol % CO₂ at 30° C.

14. The method of claim 1, wherein the organosilica material, at maximum CO₂ capacity, has an amine utilization of greater than 0.30, the amine utilization defined as the molar ratio of CO₂ sorbed by the organosilica material to the nitrogen in the organosilica material.

15. The method of claim 14, wherein the grafted organosilica material, at maximum CO₂ capacity, has an amine utilization of greater than 0.30, the amine utilization defined as the molar ratio of CO₂ sorbed by the grafted organosilica material to the nitrogen in the grafted organosilica material.

16. The method of claim 1, wherein R¹¹, R¹², R¹³, R¹⁴, R¹⁵, and R¹⁶ each represent a hydrogen atom.
